(19) United States
(12) Patent Application Publication
(10) Pub. No.: US 2026/0135337 A1
(43) Pub. Date: May 14, 2026

(54) TERMINAL MODULE WITH IMPROVED SHIELDING PIECE, MANUFACTURING METHOD THEREOF, AND APPLICATION THEREOF

(71) Applicant: SPEED TECH CORPORATION, Taoyuan City (TW)

(72) Inventors: Ho-Chang CHEN, Taoyuan City (TW); Hua-Chun CHANG, Taoyuan City (TW); Li-Sen CHEN, Taoyuan City (TW)

(73) Assignee: SPEED TECH CORPORATION, Taoyuan City (TW)

(21) Appl. No.: 19/402,332

(22) Filed: Nov. 26, 2025

Related U.S. Application Data
(63) Continuation-in-part of application No. 19/251,175, filed on Jun. 26, 2025.

(30) Foreign Application Priority Data
Nov. 14, 2024 (CN) 202411622160.X
Feb. 21, 2025 (CN) 202510194304.4
Oct. 21, 2025 (CN) 202511503593.8

(51) Int. Cl. H01R 13/6585; H01R 43/24

(52) U.S. Cl. CPC H01R 13/6585; H01R 43/24

(57) ABSTRACT

A terminal module includes a number of first conductive terminals, an insulating body, and a first shielding piece. The first conductive terminals include a first outer ground terminal and a second outer ground terminal. Each first conductive terminal includes a first conductive pad. The first shielding piece includes a first shielding portion, a first side wall portion, and a second side wall portion. The first side wall portion is provided with a first abutting portion. The second side wall portion is provided with a second abutting portion. The first abutting portion is in contact with the first conductive pad of the first outer ground terminal, and the second abutting portion is in contact with the first conductive pad of the second outer ground terminal. A method of manufacturing the terminal module and an application of the terminal module are also disclosed.

### CROSS-REFERENCE TO RELATED APPLICATIONS

This patent application is a continuation-in-part of U.S. patent application Ser. No. 19/251,175, filed on Jun. 26, 2025, which claims priorities of a Chinese Patent Application No. 202510194304.4, filed on Feb. 21, 2025 and titled “TERMINAL MODULE, MANUFACTURING METHOD THEREOF, AND APPLICATION THEREOF”, and a Chinese Patent Application No. 202411622160.X, filed on Nov. 14, 2024 and titled “TERMINAL MODULE, MANUFACTURING METHOD THEREOF, AND APPLICATION THEREOF”. This patent application further claims priority of a Chinese Patent Application No. 202511503593.8, filed on Oct. 21, 2025 and titled “TERMINAL MODULE, MANUFACTURING METHOD THEREOF, AND APPLICATION THEREOF”. The contents of the aforementioned applications are incorporated herein by reference in their entirety.

### TECHNICAL FIELD

The present disclosure relates to a terminal module, a manufacturing method of the terminal module, and an application of the terminal, which belongs to the technical field of electrical connector components.

### BACKGROUND

Some conventional electrical connectors include components made from printed circuit boards (PCBs), such as tongue plates or adapter modules. The PCB typically includes a plurality of first conductive pads, a plurality of second conductive pads, and a plurality of internal conductive traces formed inside the PCB.

However, it is understandable to those of ordinary skill in the art, due to limitations in PCB manufacturing processes, controlling geometric dimensions (e.g., thickness) is challenging, which leads to impedance mismatches and difficulties in meeting high-speed signal transmission requirements.

Besides, how to improve the shielding of a conductive piece during signal transmission is also a technical problem to be solved by those skilled in the art.

Therefore, it is desirable to improve the PCBs in the related technology.

### SUMMARY

An embodiment of the present disclosure adopts the following technical solution: a terminal module including: a plurality of first conductive terminals, the plurality of first conductive terminals including a first outer ground terminal, a second outer ground terminal, and at least one signal terminal located between the first outer ground terminal and the second outer ground terminal; each first conductive terminal including a first conductive pad, a second conductive pad, and a first intermediate portion connecting the first conductive pad and the second conductive pad; the first conductive pad and the second conductive pad being disposed at intervals along a first direction; an insulating body, the insulating body including a first surface and a second surface disposed opposite to the first surface along a second direction; the first conductive pads and the second conductive pads are exposed on the first surface; and a first shielding piece, the first shielding piece including a first shielding portion at least partially disposed in the insulating body, a first side wall portion bent from one side of the first shielding portion, and a second side wall portion bent from another side of the first shielding portion; the first shielding portion corresponding to the first conductive pads; the first side wall portion being provided with a first abutting elastic arm; the first abutting elastic arm being provided with a first abutting portion; the second side wall portion being provided with a second abutting elastic arm; the second abutting elastic arm being provided with a second abutting portion; the first abutting portion being in contact with the first conductive pad of the first outer ground terminal; and the second abutting portion being in contact with the first conductive pad of the second outer ground terminal.

An embodiment of the present disclosure adopts the following technical solution: a terminal module including: a first terminal assembly, the first terminal assembly including: a plurality of first conductive terminals, the plurality of first conductive terminals including a first outer ground terminal, a second outer ground terminal, and at least one first signal terminal located between the first outer ground terminal and the second outer ground terminal; each first conductive terminal including a first conductive pad extending along a first direction; a first insulating block, the first insulating blocking being secured with the plurality of first conductive terminals; and a first shielding piece, the first shielding piece including a first shielding portion at least partially disposed in the first insulating block, a first side wall portion bent from one side of the first shielding portion, and a second side wall portion bent from another side of the first shielding portion; the first shielding portion corresponding to the first conductive pads; the first side wall portion being provided with at least one first abutting elastic arm; the at least one first abutting elastic arm being provided with at least one first abutting portion; the second side wall portion being provided with at least one second abutting elastic arm; the at least one second abutting elastic arm being provided with at least one second abutting portion; the first abutting portion being in contact with the first conductive pad of the first outer ground terminal; and the second abutting portion being in contact with the first conductive pad of the second outer ground terminal; and a second terminal assembly, the second terminal assembly including: a plurality of second conductive terminals, the plurality of second conductive terminals including a third outer ground terminal, a fourth outer ground terminal, and at least one second signal terminal located between the third outer ground terminal and the fourth outer ground terminal; each second conductive terminal including a second conductive pad extending along the first direction; a second insulating block, the second insulating blocking being secured with the plurality of second conductive terminals; and a second shielding piece, the second shielding piece including a second shielding portion at least partially disposed in the second insulating block, a third side wall portion bent from one side of the second shielding portion, and a fourth side wall portion bent from another side of the second shielding portion; the second shielding portion corresponding to the second conductive pads; the third side wall portion being provided with at least one third abutting elastic arm; the at least one third abutting elastic arm being provided with at least one third abutting portion; the fourth side wall portion being provided with at least one fourth abutting elastic arm; the at least one fourth abutting elastic arm being provided with at least one fourth abutting portion; the third abutting portion being in contact with the second conductive pad of the third outer ground terminal; and the fourth abutting portion being in contact with the second conductive pad of the fourth outer ground terminal; wherein the first shielding portion of the first shielding piece and the second shielding portion of the second shielding piece together form a first shielding layer located between the first conductive pads of the first conductive terminals and the second conductive pads of the second conductive terminals; and wherein the first shielding layer is free of any openings extending through the first shielding layer along a second direction perpendicular to the first direction, so as to reduce signal crosstalk between the first conductive pads of the first conductive terminals and the second conductive pads of the second conductive terminals.

An embodiment of the present disclosure adopts the following technical solution: a method for manufacturing the above-mentioned terminal module, including: providing the plurality of first conductive terminals; providing the first shielding piece; injection-molding a first insulating block on the first conductive terminals and the first shielding piece to form a first terminal assembly; providing the plurality of second conductive terminals; providing the second shielding piece; injection-molding a second insulating block on the second conductive terminals and the second shielding piece to form a second terminal assembly; assembling the first terminal assembly and the second terminal assembly together; and injection-molding a third insulating block on the first terminal assembly and the second terminal assembly to form the insulating body.

An embodiment of the present disclosure adopts the following technical solution: an application of the above-mentioned terminal module, wherein the terminal module is a component of an electrical connector, and the terminal module is configured to replace a printed circuit board.

### BRIEF DESCRIPTION OF DRAWINGS

FIG. 1 is a perspective schematic view of a terminal module in accordance with a first embodiment of the present disclosure;

FIG. 2 is a perspective schematic view of FIG. 1 in another angle;

FIG. 3 is a top view of FIG. 1;

FIG. 4 is a bottom view of FIG. 1;

FIG. 5 is a partial perspective exploded view of FIG. 1;

FIG. 6 is a partial perspective exploded view of FIG. 5 in another angle;

FIG. 7 is a perspective exploded view of a first terminal assembly of FIG. 6;

FIG. 8 is a perspective exploded view of FIG. 7 in another angle;

FIG. 9 is a perspective exploded view of a second terminal assembly of FIG. 5;

FIG. 10 is a perspective exploded view of FIG. 9 in another angle;

FIG. 11 is a schematic cross-sectional view taken along line B-B of FIG. 1;

FIG. 12 is a perspective exploded view of the first terminal assembly of FIG. 7 in accordance with a second embodiment of the present disclosure;

FIG. 13 is a schematic cross-sectional view of the terminal module in accordance with a second embodiment of the present disclosure;

FIG. 14 is a schematic cross-sectional view of the terminal module in accordance with a third embodiment of the present disclosure;

FIG. 15 is a schematic cross-sectional view of the terminal module in accordance with a fourth embodiment of the present disclosure;

FIG. 16 is a schematic cross-sectional view of the terminal module in accordance with a fifth embodiment of the present disclosure;

FIG. 17 is a schematic view of the terminal module in one application of the present disclosure;

FIG. 18 is a schematic view of the terminal module in another application of the present disclosure;

FIG. 19 is a schematic cross-sectional view of the terminal module in accordance with a sixth embodiment of the present disclosure;

FIG. 20 is a partially enlarged view of circled portion C of FIG. 19;

FIG. 21 is a partially enlarged view of circled portion D of FIG. 19;

FIG. 22 is a schematic cross-sectional view of the terminal module in accordance with the sixth embodiment of the present disclosure;

FIG. 23 is a schematic cross-sectional view of the terminal module in accordance with a seventh embodiment of the present disclosure;

FIG. 24 is a schematic cross-sectional view of the terminal module in accordance with an eighth embodiment of the present disclosure;

FIG. 25 is a schematic cross-sectional view of the terminal module in accordance with a ninth embodiment of the present disclosure;

FIG. 26 is a schematic cross-sectional view of the terminal module in accordance with a tenth embodiment of the present disclosure;

FIG. 27 is a partial exploded perspective view of the terminal module in accordance with an eleventh embodiment of the present disclosure;

FIG. 28 is a partial enlarged view of framed portion E in FIG. 27;

FIG. 29 is a partial exploded perspective view of FIG. 27 from another angle;

FIG. 30 is an exploded perspective view of the first terminal assembly in FIG. 27;

FIG. 31 is an exploded perspective view of the second terminal assembly in FIG. 27;

FIG. 32 is an exploded perspective view of FIG. 30 from another angle;

FIG. 33 is an exploded perspective view of FIG. 31 from another angle;

FIG. 34 is a partial perspective schematic view of the terminal module in accordance with the eleventh embodiment of the present disclosure, with the insulating body not shown;

FIG. 35 is a top view of FIG. 34;

FIG. 36 is a bottom view of FIG. 34;

FIG. 37 is a right-side view of FIG. 34;

FIG. 38 is a left-side view of FIG. 34;

FIG. 39 is a cross-sectional schematic view of the terminal module in accordance with the eleventh embodiment of the present disclosure taken along line F-F in FIG. 35;

FIG. 40 is a cross-sectional schematic view of the terminal module in accordance with the eleventh embodiment of the present disclosure taken along line H-H in FIG. 35;

FIG. 41 is a partial exploded perspective view of the terminal module in accordance with a twelfth embodiment of the present disclosure;

FIG. 42 is a partial exploded perspective view of FIG. 41 from another angle;

FIG. 43 is an exploded perspective view of the first terminal assembly in FIG. 41;

FIG. 44 is an exploded perspective view of the second terminal assembly in FIG. 41;

FIG. 45 is an exploded perspective view of FIG. 43 from another angle;

FIG. 46 is an exploded perspective view of FIG. 44 from another angle;

FIG. 47 is a partial perspective schematic view of the terminal module in accordance with the twelfth embodiment of the present disclosure, with the insulating body not shown;

FIG. 48 is a top view of FIG. 47;

FIG. 49 is a bottom view of FIG. 47;

FIG. 50 is a right-side view of FIG. 47;

FIG. 51 is a left-side view of FIG. 47;

FIG. 52 is a cross-sectional schematic view of the terminal module in accordance with the twelfth embodiment of the present disclosure taken along line I-I in FIG. 48;

FIG. 53 is a cross-sectional schematic view of the terminal module in accordance with the twelfth embodiment of the present disclosure taken along line J-J in FIG. 48; and

FIG. 54 is a cross-sectional schematic view of the terminal module in accordance with the twelfth embodiment of the present disclosure taken along line K-K in FIG. 48.

It is understandable to those skilled in the art that the accompanying drawings provided herein are for illustrative purposes of the specific embodiments of the present disclosure, and the proportions shown in the drawings are only for the illustrated embodiments, and other embodiments may not necessarily be implemented to scale.

### DETAILED DESCRIPTION

Exemplary embodiments will be described in detail here, examples of which are shown in drawings. When referring to the drawings below, unless otherwise indicated, same numerals in different drawings represent the same or similar elements. The examples described in the following exemplary embodiments do not represent all embodiments consistent with this application. Rather, they are merely examples of devices and methods consistent with some aspects of the application as detailed in the appended claims.

The terminology used in this application is only for the purpose of describing particular embodiments, and is not intended to limit this application. The singular forms “a”, “said”, and “the” used in this application and the appended claims are also intended to include plural forms unless the context clearly indicates other meanings.

It should be understood that the terms “first”, “second” and similar words used in the specification and claims of this application do not represent any order, quantity or importance, but are only used to distinguish different components. Similarly, “an” or “a” and other similar words do not mean a quantity limit, but mean that there is at least one; “multiple” or “a plurality of” means two or more than two. Unless otherwise noted, “front”, “rear”, “lower” and/or “upper” and similar words are for ease of description only and are not limited to one location or one spatial orientation. Similar words such as “include” or “comprise” mean that elements or objects appear before “include” or “comprise” cover elements or objects listed after “include” or “comprise” and their equivalents, and do not exclude other elements or objects. The term “a plurality of” mentioned in the present disclosure includes two or more.

Hereinafter, some embodiments of the present disclosure will be described in detail with reference to the accompanying drawings. In the case of no conflict, the following embodiments and features in the embodiments can be combined with each other.

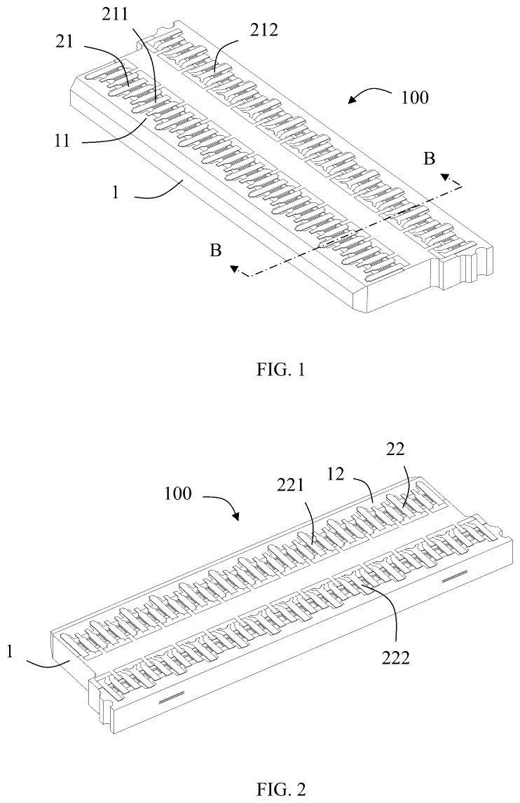

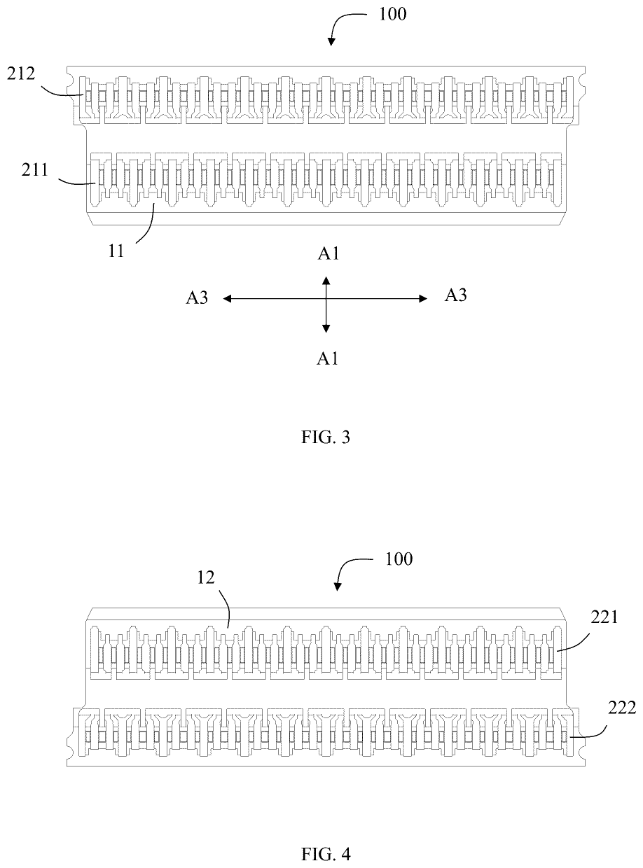

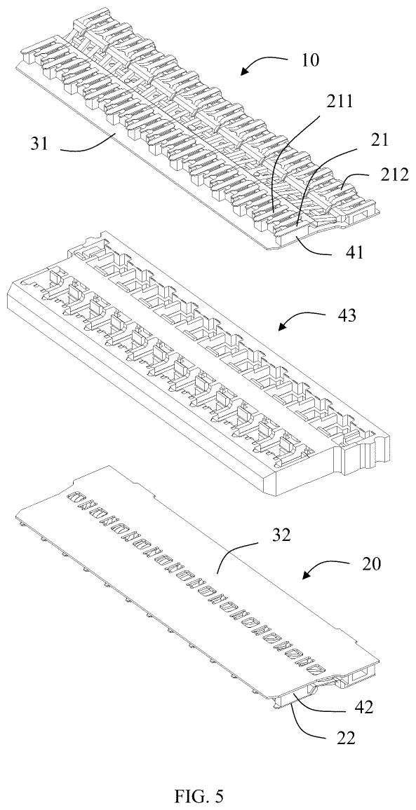

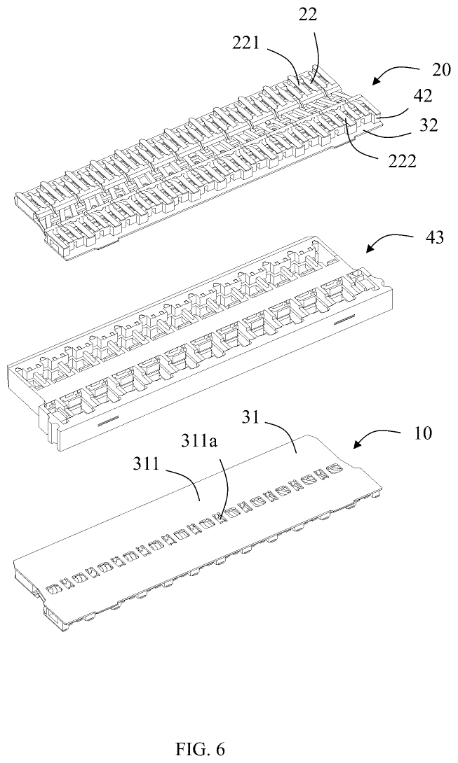

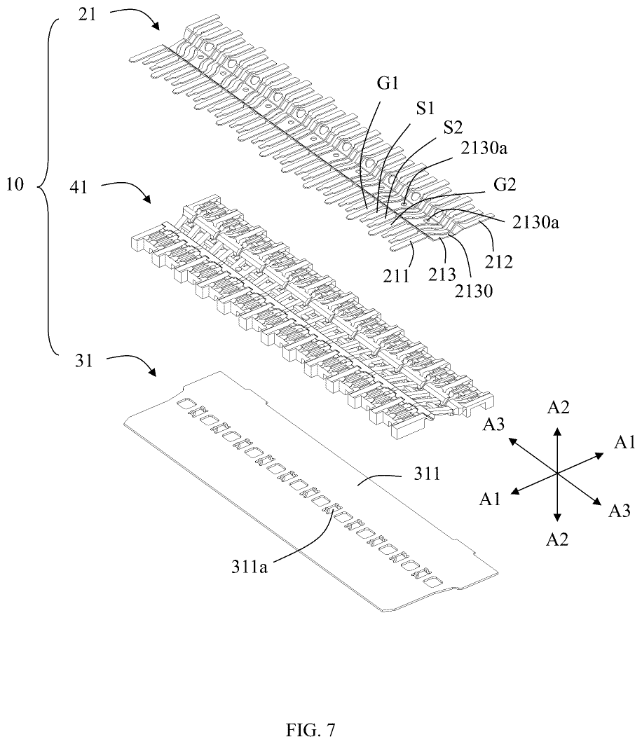

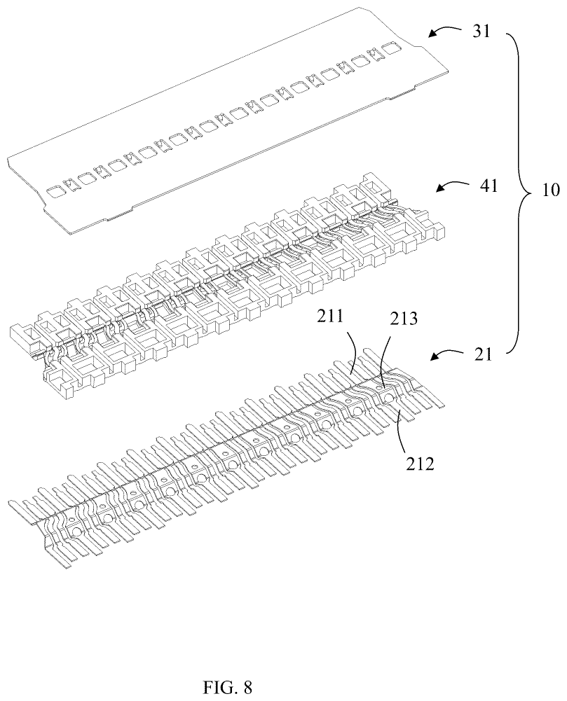

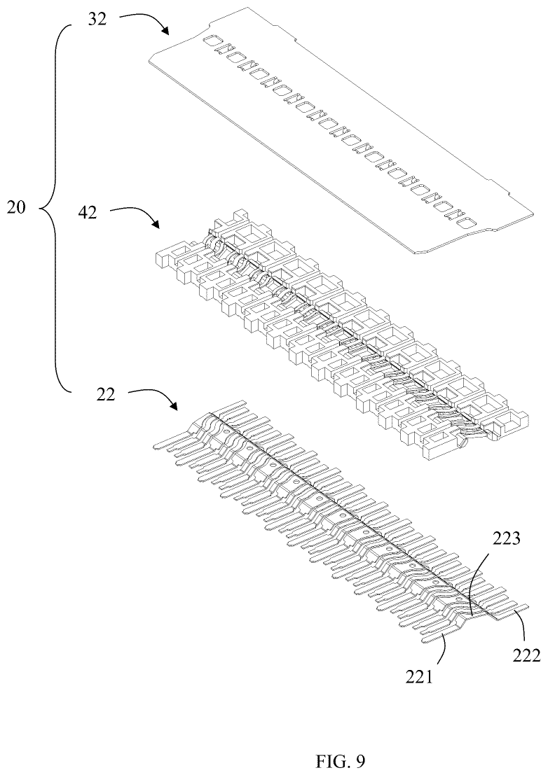

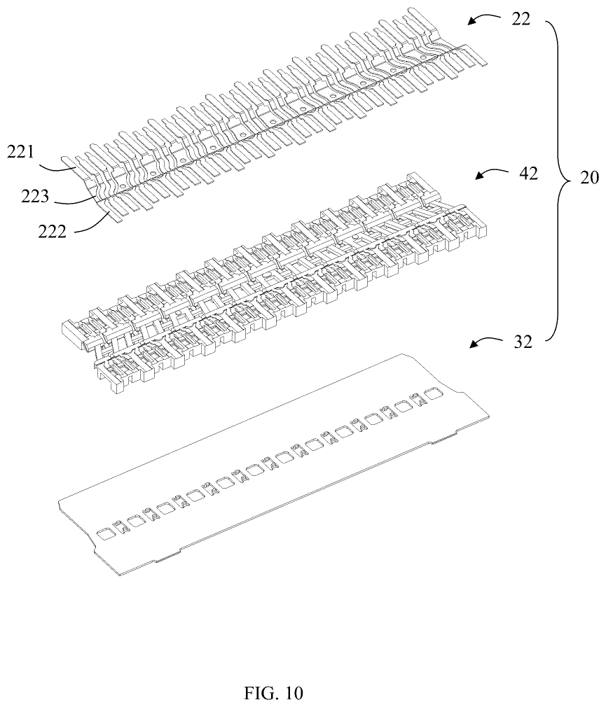

Referring to FIG. 1 to FIG. 11, a first embodiment of the present disclosure discloses a terminal module 100, including a plurality of first conductive terminals 21, an insulating body 1, and a first shielding piece 31. Specifically, in the first embodiment of the present disclosure, the terminal module 100 further includes a plurality of second conductive terminals 22 and a second shielding piece 32. Besides, to facilitate assembly, the terminal module 100 includes a first terminal assembly 10 and a second terminal assembly 20. The first terminal assembly 10 includes a first insulating block 41 fixed to the first conductive terminals 21 and the first shielding piece 31 to form an integral unit. Similarly, the second terminal assembly 20 includes a second insulating block 42 fixed to the second conductive terminals 22 and the second shielding piece 32 to form another integral unit. The terminal module 100 further includes a third insulating block 43 over-molded on the first terminal assembly 10 and the second terminal assembly 20. It is understandable to those skilled in the art that after the third insulating block 43 is molded on the first insulating block 41 and the second insulating block 42, the three components integrate into a single unit, collectively referred to as the insulating body 1.

In the first embodiment of the present disclosure, the first insulating block 41 is injection-molded on the first conductive terminals 21. Each first conductive terminal 21 includes a first conductive pad 211, a second conductive pad 212, and a first intermediate portion 213 connecting the first conductive pad 211 and the second conductive pad 212. The first conductive pad 211 and the second conductive pad 212 are disposed at intervals along a first direction A1-A1 (for example, a front-rear direction). In one application of the present disclosure, the first conductive pads 211 are configured to be in contact with a mating connector (not shown), while the second conductive pads 212 are configured to electrically connect to a cable (not shown), such as via soldering or welding. The first intermediate portion 213 includes a first embedded portion 2130 embedded in the insulating body 1 and spaced away from the first conductive pad 211 along a second direction A2-A2 (for example, a top-bottom direction). The second direction A2-A2 is perpendicular to the first direction A1-A1.

The insulating body 1 includes a first surface 11 and a second surface 12 disposed opposite to the first surface along the second direction A2-A2. In the illustrated embodiment of the present disclosure, both the first conductive pad 211 and the second conductive pad 212 are exposed on the first surface 11. In one embodiment of the present disclosure, a first outer surface 2111 (for example, an upper surface) of the first conductive pad 211 and a second outer surface 2121 (for example, an upper surface) of the second conductive pad 212 lie in a same plane. Alternatively, the first outer surface 2111 of the first conductive pad 211 and the second outer surface 2121of the second conductive pad 212 may lie in different planes. The first intermediate portion 213 extends from the first surface 11 toward the second surface 12 along the second direction A2-A2. In the illustrated embodiment of the present disclosure, the insulating body 1 further includes a first covering portion 13 covering the first intermediate portion 213. The first covering portion 13 is located between the first conductive pad 211 and the second conductive pad 212 along the first direction A1-A1. The first conductive pad 211, the first covering portion 13, and the second conductive pad 212 are substantially flat. It is understandable to those skilled in the art that a slight undulation among the first conductive pad 211, the first covering portion 13 and the second conductive pad 212, including, but not limited to, those caused by manufacturing variations, is still considered to be “substantially flat”. The first covering portion 13 has a third outer surface 131. Preferably, the first outer surface 2111, the second outer surface 2121 and the third outer surface 131 lie in the same plane.

Additionally, in the illustrated embodiment of the present disclosure, the second conductive pad 212 is deflected outward relative to the first conductive pad 211 along a third direction A3-A3 (for example, a left-right direction). The third direction A3-A3 is perpendicular to the first direction A1-A1 and the second direction A2-A2. Among the plurality of first conductive terminals 21, the second conductive pads 212 occupy a greater distance along the third direction A3-A3 than the first conductive pads 211 occupy along the third direction A3-A3. As a result, when the second conductive pads 212 and the cable are soldered or welded together, it is possible to reduce the risk of short-circuiting due to the small spacing between the second conductive pads 212.

In the illustrated embodiment of the present disclosure, the plurality of first conductive terminals 21 include a first signal terminal S1, a second signal terminal S2, a first ground terminal G1 and a second ground terminal G2. the first signal terminal S1 and the second signal terminal S2 are disposed adjacent to each other along the third direction A3-A3 and form a first signal terminal group. The first ground terminal G1 is located on one side of the first signal terminal group along the third direction A3-A3. The second ground terminal G2 is located on another side of the first signal terminal group along the third direction A3-A3. The terminal layout of G1-S1-S2-G2 of the present disclosure facilitates improved quality of signal transmission. In the illustrated embodiment of the present disclosure, in order to provide a better ground shielding effect, the first conductive pad 211 of the first ground terminal G1 as well as the first conductive pad 211 of the second ground terminal G2 extend forwardly beyond the first conductive pad 211 of the first signal terminal S1 and the first conductive pad 211 of the second signal terminal S2 in the first direction A1-A1. Besides, the second conductive pad 212 of the first ground terminal G1 and the second conductive pad 212 of the second ground terminal G2 both extend backwardly beyond the second conductive pad 212 of the first signal terminal S1 and the second conductive pad 212 of the second signal terminal S2 along the first direction A1-A1.

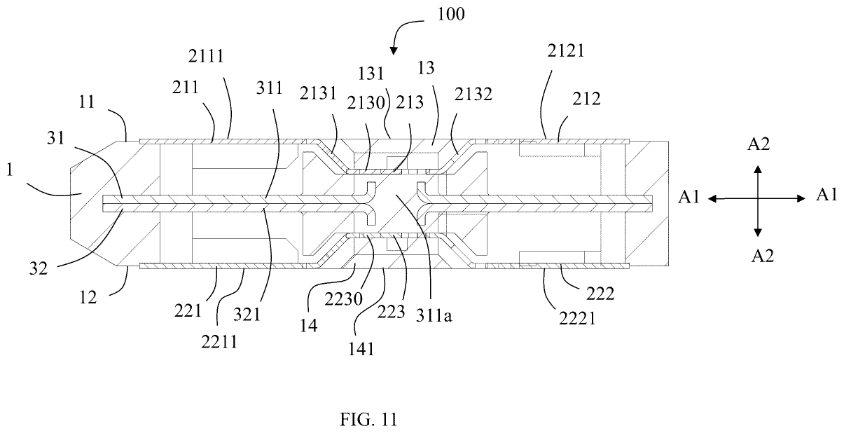

The first shielding piece 31 is made of a metallic material, and includes a first plate portion 311 at least partially embedded in the insulating body 1. The first embedded portion 2130 is located between the first conductive pad 211 and the first plate portion 311 along the second direction A2-A2. As a result, the first embedded portion 2130 is able to function as a conductive path similar to conductive traces of a printed circuit board. As shown in FIG. 11, in the illustrated embodiment of the present disclosure, the first plate portion 311 extends forwardly beyond the first conductive pad 211 along the first direction A1-A1, and the first plate portion 311 extends backwardly beyond the second conductive pad 212 along the first direction A1-A1 to provide a better shielding effect over the entire length of the first conductive pad 211 as well as the second conductive pad 212.

In the first embodiment of the present disclosure, the first plate portion 311 defines a first opening 311a extending through the first plate portion 311 along the second direction A2-A2. The first shielding piece 31 is either assembled to the first insulating block 41, or the first insulating block 41 is inject-molded on the first shielding piece 31.

Specifically, the first intermediate portion 213 includes a first connecting portion 2131 connected between the first embedded portion 2130 and the first conductive pad 211, and a second connecting portion 2132 connected between the first embedded portion 2130 and the second conductive pad 212.

In the first embodiment of the present disclosure, both the first connecting portion 2131 and the second connecting portion 2132 are inclined. The first embedded portion 2130 is flat. In the first embodiment of the present disclosure, each of the first embedded portion 2130 of the first ground terminal G1 and the first embedded portion 2130 of the second ground terminal G2 defines a first through hole 2130a extending through the first embedded portion 2130 in the second direction A2-A2. The insulating body 1 fills the first through hole 2130a and the first opening 311a to enhance the retention force.

In various embodiments illustrated in the present disclosure, the second terminal assembly 20 is symmetrically arranged with the first terminal assembly 10. That is, the first conductive terminals 21 are symmetrically arranged with the second conductive terminals 22, and the first shielding piece 31 is arranged symmetrically with the second shielding piece 32. Preferably, the first terminal assembly 10 is identical to the second terminal assembly 20 to be able to share parts and save costs.

The second conductive terminal 22 includes a third conductive pad 221, a fourth conductive pad 222, and a second intermediate portion 223 connecting the third conductive pad 221 and the fourth conductive pad 222. The third conductive pad 221 and the fourth conductive pad 222 are disposed at intervals in the first direction A1-A1. The second intermediate portion 223 extends from the second surface 12 toward the first surface 11 in the second direction A2-A2. The second intermediate portion 223 includes a second embedded portion 2230 embedded in the insulating body 1 and disposed away from the third conductive pad 221 in the second direction A2-A2.

In one embodiment of the present disclosure, the fourth outer surface 2211 (for example, a lower surface) of the third conductive pad 221 is located in the same plane as the fifth outer surface 2221 (for example, a lower surface) of the fourth conductive pad 222. In the illustrated embodiment of the present disclosure, the insulating body 1 includes a second covering portion 14 covering the second intermediate portion 223. The second covering portion 14 is located between the third conductive pad 221 and the fourth conductive pad 222 in the first direction A1-A1. The third conductive pad 221, the second covering portion 14 and the fourth conductive pad 222 are substantially flat. It is understandable to those skilled in the art that a slight undulation among the third conductive pad 221, the second covering portion 14 and the fourth conductive pad 222 including, but not limited to, those caused by manufacturing variations, is still considered to be “substantially flat”. The second covering portion 14 has a sixth outer surface 141. Preferably, the sixth outer surface 141 of the second covering portion 14, the fourth outer surface 2211 of the third conductive pad 221, and the fifth outer surface 2221 of the fourth conductive pad 222 are located in the same plane.

The second shielding piece 32 includes a second plate portion 321 at least partially embedded in the insulating body 1. The second embedded portion 2230 is located between the third conductive pad 221 and the second plate portion 321 in the second direction A2-A2.

Other structures of the second terminal assembly 20 may refer to the description of the first terminal assembly 10, which will not be repeated in the present disclosure.

In order to improve the shielding effect, in various embodiments of the present disclosure, the first plate portion 311 of the first shielding piece 31 is electrically connected to the second plate portion 321 of the second shielding piece 32. For example, the first plate portion 311 of the first shielding piece 31 is in contact with the second plate portion 321 of the second shielding piece 32.

In the first embodiment of the present disclosure, the first shielding piece 31 is not in contact with the first ground terminal G1 and the second ground terminal G2.

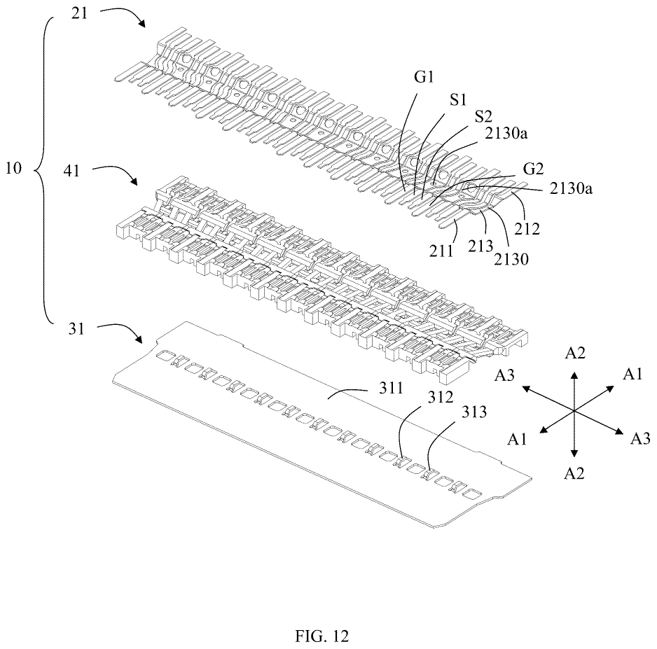

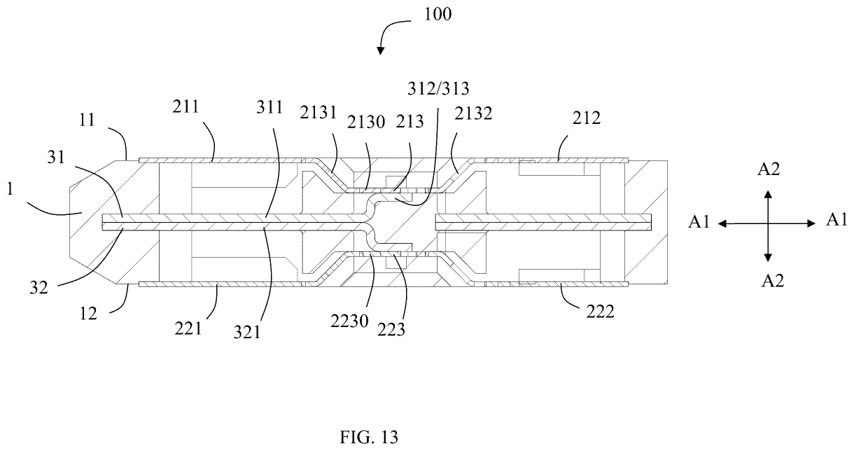

Referring to FIG. 12 and FIG. 13, in a second embodiment of the present disclosure, the first shielding piece 31 is electrically connected to the first embedded portion 2130 of the first ground terminal G1. The first shielding piece 31 is electrically connected to the first embedded portion 2130 of the second ground terminal G2. Specifically, the first shielding piece 31 is provided with a first protrusion tab 312 in contact with the first embedded portion 2130 of the first ground terminal G1, and a second protrusion tab 313 in contact with the first embedded portion 2130 of the second ground terminal G2. Preferably, the first protrusion tab 312 and the second protrusion tab 313 are formed by integrally stamping from the first embedded portion 2130.

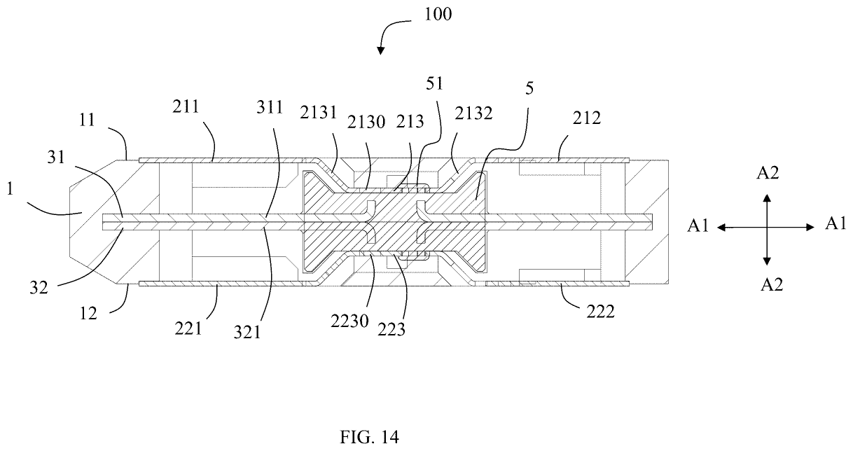

Referring to FIG. 14, in a third embodiment of the present disclosure, the first shielding piece 31 is electrically connected to the first embedded portion 2130 of the first ground terminal G1. The first shielding piece 31 is electrically connected to the first embedded portion 2130 of the second ground terminal G2. Specifically, the terminal module 100 is provided with a first conductive block 5 fixed to the first shielding piece 31 and the second shielding piece 32. The first conductive block 5 is made of a metal conductor or a wave absorbing material. The first conductive block 5 connects the first shielding piece 31 and the first embedded portion 2130 of the first ground terminal G1, and the first conductive block 5 connects the first shielding piece 31 and the first embedded portion 2130 of the second ground terminal G2. Each of the first embedded portion 2130 of the first ground terminal G1 and the first embedded portion 2130 of the second ground terminal G2 defines a first through hole 2130a. The first conductive block 5 includes a plurality of first mounting posts 51 fixed in corresponding first through holes 2130a.

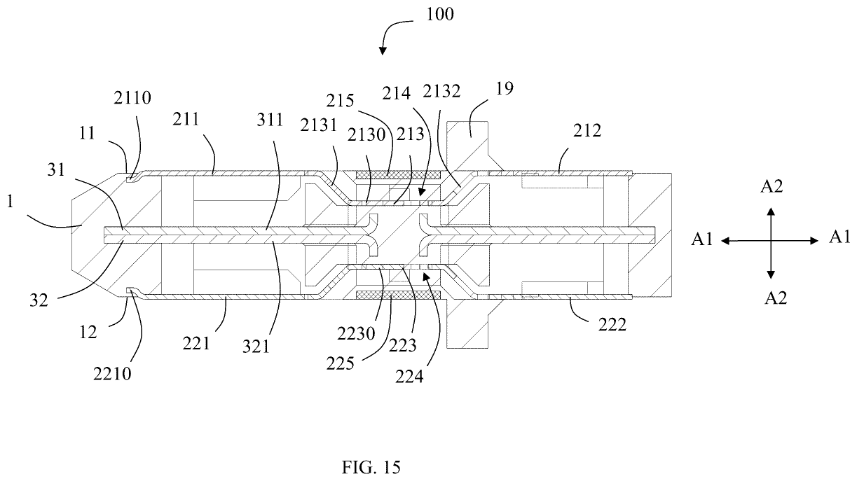

Referring to FIG. 15, in a fourth embodiment of the present disclosure, the first conductive terminal 21 includes a first recess 214 located outside (for example, an upper end) the first intermediate portion 213 in the second direction A2-A2. The first recess 214 is located between the first conductive pad 211 and the second conductive pad 212 in the first direction A1-A1. Similarly, the second conductive terminal 22 includes a second recess 224 located outside (for example, a lower end) of the second intermediate portion 223 in the second direction A2-A2. The second recess 224 is located between the third conductive pad 221 and the fourth conductive pad 222 in the first direction A1-A1.

The terminal module 100 further includes a first shielding plate 215 fixed to the insulating body 1 and corresponding to the first recess 214, and a second shielding plate 225 fixed to the insulating body 1 and corresponding to the second recess 224. The first shielding plate 215 is exposed on the first surface 11. The second shielding plate 225 is exposed on the second surface 12. By providing the first shielding plate 215 and the second shielding plate 225, it is beneficial to further improve the shielding effect and improve the quality of signal transmission. At this time, the insulating body 1 may also be provided with a first holding protrusion 19 extending upwardly beyond the first surface 11. Preferably, the first holding protrusion 19 presses against a joint between the second connecting portion 2132 and the second conductive pad 212 to increase the retention force between the first conductive terminal 21 and the first insulating block 41, thereby reducing the risk of loosening between the two.

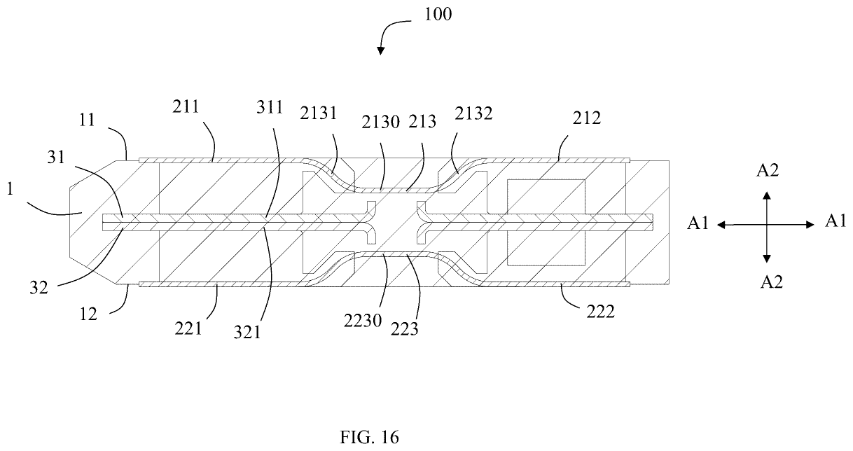

Referring to FIG. 16, in a fifth embodiment of the present disclosure, the first embedded portion 2130 is of an arc shape. The first connecting portion 2131 is of an arc shape. The second connecting portion 2132 is of an arc shape. As a result, the first intermediate portion 213 itself, the connection position of the first intermediate portion 213 and the first conductive pad 211, and the connection position of the first intermediate portion 213 and the second conductive pad 212 can be smoothly over.

Referring to FIG. 15, it is understandable to those skilled in the art that in order to increase the retention force between the first conductive terminal 21 and the first insulating block 41, and reduce the risk of loosening between the two, the first conductive terminal 21 may also include a first retaining portion 2110 connected to the first conductive pad 211. In the illustrated embodiment of the present disclosure, the first retaining portion 2110 and the first conductive pad 211 are in a step shape. That is, the first retaining portion 2110 and the first conductive pad 211 are not in a same plane. As a result, although the first conductive pad 211 needs to be exposed on the first surface 11, the first retaining portion 2110 may still be embedded and fixed in the insulating body 1 to increase the retention force. Based on the same design concept, the insulating body 1 can also add a first retaining portion of a raised feature to cover the upper surface of the corresponding portion of the first conductive terminal 21 to increase the retention force and prevent the first conductive terminal 21 from being peeled off. Of course, it is understandable to those skilled in the art that the shape of the first retaining portion 2110 can be flexibly adjusted as needed, for example, bent in an inclined or arced surface.

Similarly, referring to FIG. 15, it is understandable to those skilled in the art that in order to increase the retention force between the second conductive terminal 22 and the second insulating block 42, and reduce the risk of loosening between the two, the second conductive terminal 222 may also include a second retaining portion 2210 connected to the third conductive pad 221. In the illustrated embodiment of the present disclosure, the second retaining portion 2210 and the third conductive pad 221 are in a step shape. That is, the second retaining portion 2210 and the third conductive pad 221 are not in a same plane. As a result, although the third conductive pad 221 needs to be exposed on the second surface 12, the second retaining portion 2210 may still be embedded and fixed in the insulating body 1 to increase the retention force. Based on the same design concept, the insulating body 1 can also add a second retaining portion of a raised feature to cover the lower surface of the corresponding portion of the second conductive terminal 22 to increase the retention force and prevent the second conductive terminal 22 from being peeled off. Of course, it is understandable to those skilled in the art that the shape of the second retaining portion 2210 can be flexibly adjusted as needed, for example, bent in an inclined or arced surface.

By providing the first retaining portion 2110 and the second retaining portion 2210, and securing them with the first insulating block 41 and the second insulating block 42, respectively, the present disclosure is conducive to improving the mating reliability of the first conductive pad 211 and the third conductive pad 221.

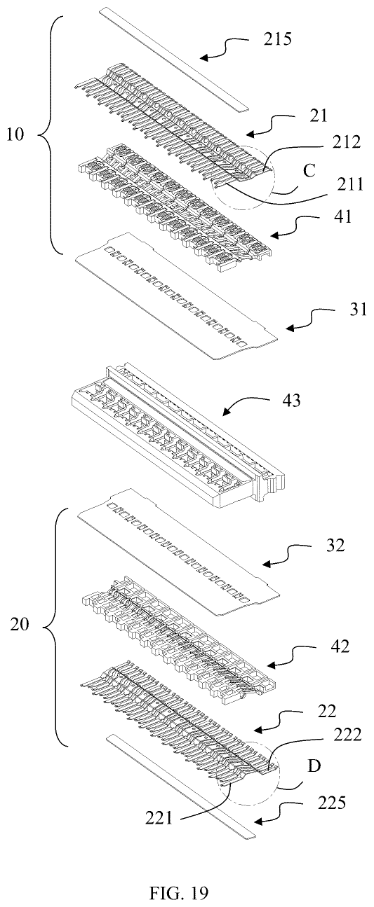

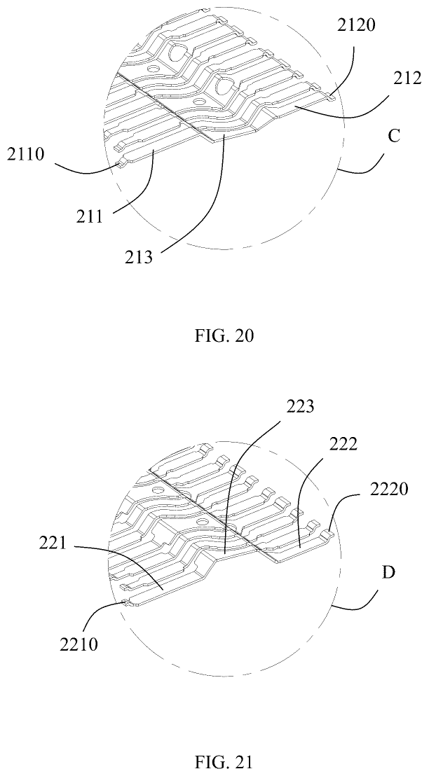

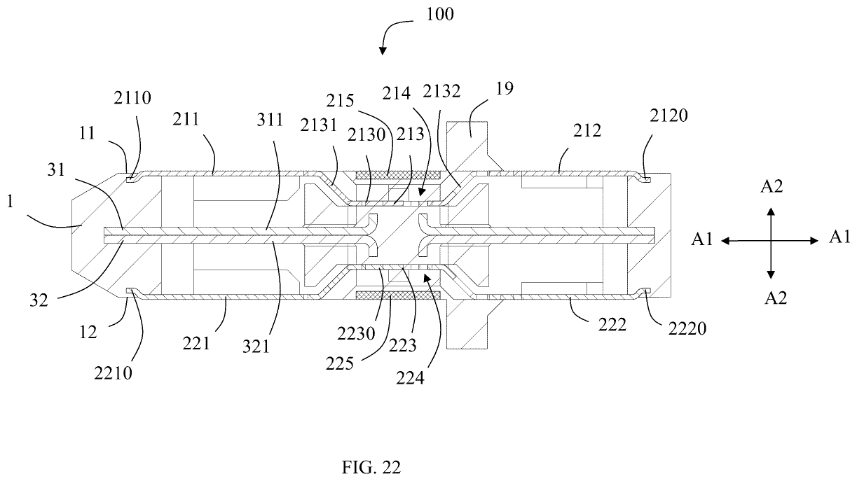

Referring to FIG. 19 to FIG. 22, the terminal module in a sixth embodiment of the present disclosure is similar to the terminal module in the fourth embodiment shown in FIG. 15. The following describes only the main differences between the two.

Referring to FIG. 19 to FIG. 22, in the sixth embodiment of the present disclosure, it is understandable to those skilled in the art that in order to increase the retention force between the first conductive terminal 21 and the first insulating block 41, and reduce the risk of loosening between the two, the first conductive terminal 21 may also include a first fixing portion 2120 connected to the second conductive pad 212. In the illustrated embodiment of the present disclosure, the first fixing portion 2120 and the second conductive pad 212 are in a step shape. That is, the first fixing portion 2120 and the second conductive pad 212 are not in a same plane. As a result, although the second conductive pad 212 needs to be exposed on the first surface 11, the first fixing portion 2120 can still be embedded and fixed in the insulating body 1 to increase the retention force. Based on the same design concept, the insulating body 1 can also add a third retaining portion of a raised feature to cover the upper surface of the corresponding portion of the first conductive terminal 21 to increase the retention force and prevent the first conductive terminal 21 from being peeled off. As a result, the present disclosure improves the structural reliability when the second conductive pad 212 is electrically connected (for example, soldered or welded) to a cable. Of course, it is understandable to those skilled in the art that the shape of the first fixing portion 2120 can be flexibly adjusted as needed, for example, bent in an inclined or arced surface.

Similarly, referring to FIG. 19 to FIG. 22, in the sixth embodiment of the present disclosure, it is understandable to those skilled in the art that in order to increase the retention force between the second conductive terminal 22 and the second insulating block 42, and reduce the risk of loosening between the two, the second conductive terminal 22 may also include a second fixing portion 2220 connected to the fourth conductive pad 2222. In the illustrated embodiment of the present disclosure, the second fixing portion 2220 and the fourth conductive pad 222 are in a step shape. That is, the second fixing portion 2220 and the fourth conductive pad 222 are not in a same plane. As a result, although the fourth conductive pad 222 needs to be exposed on the second surface 12, the second fixing portion 2220 can still be embedded and fixed in the insulating body 1 to increase the retention force. Based on the same design concept, the insulating body 1 can also add a fourth retaining portion of a raised feature to cover the lower surface of the corresponding portion of the second conductive terminal 22 to increase the retention force and prevent the second conductive terminal 22 from being peeled off. The present disclosure improves the structural reliability of the fourth conductive pad 222 when the fourth conductive pad 222 is electrically connected (for example, soldered or welded) to a cable. Of course, it is understandable to those skilled in the art that the shape of the second fixing portion 2220 can be flexibly adjusted as needed, for example, bent in an inclined or arced surface.

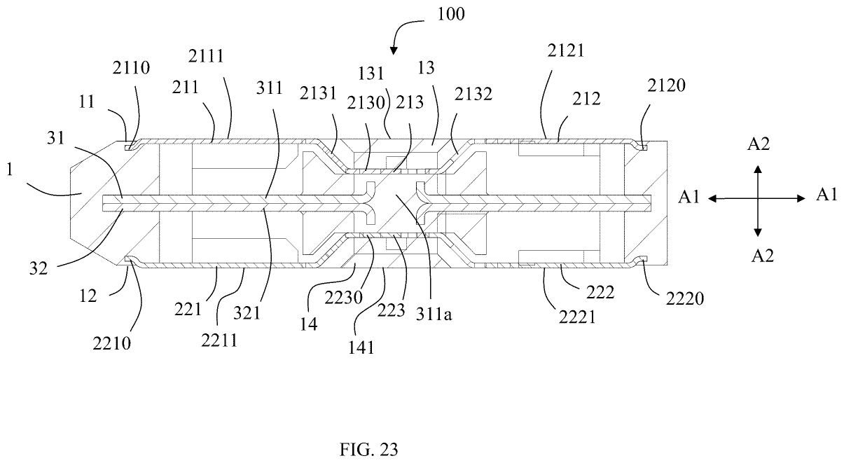

Referring to FIG. 23, the terminal module in a seventh embodiment of the present disclosure is similar to the terminal module in the first embodiment shown in FIG. 11, and the following will only describe the main differences between the two.

Referring to FIG. 23, it is understandable to those skilled in the art that in order to increase the retaining force between the first conductive terminal 21 and the first insulating block 41, and reduce the risk of loosening between the two, the first conductive terminal 21 may also include a first retaining portion 2110 connected to the first conductive pad 211 and a first retaining portion 2120 connected to the second conductive pad 212. In the illustrated embodiment of the present disclosure, the first retaining portion 2110 and the first conductive pad 211 are in a step shape. That is, the first retaining portion 2110 and the first conductive pad 211 are not in a same plane. As a result, although the first conductive pad 211 needs to be exposed on the first surface 11, the first retaining portion 2110 may still be embedded and fixed in the insulating body 1 to increase the retaining force. Based on the same design concept, the insulating body 1 can also add a first retaining portion of a raised feature to cover the upper surface of the corresponding portion of the first conductive terminal 21 to increase the retention force and prevent the first conductive terminal 21 from being peeled off. Of course, it is understandable to those skilled in the art that the shapes of the first retaining portion 2110 and the first fixing portion 2120 can be flexibly adjusted as needed, for example, bent in an inclined or arced surface. The first fixing portion 2120 and the second conductive pad 212 are in a step shape. That is, the first fixing portion 2120 and the second conductive pad 212 are not in a same plane. As a result, although the second conductive pad 212 needs to be exposed on the first surface 11, the first fixing portion 2120 may still be embedded and fixed in the insulating body 1 to increase the retention force. Based on the same design concept, the insulating body 1 can also add a third retaining portion of a raised feature to cover the upper surface of the corresponding portion of the first conductive terminal 21 to increase the retention force and prevent the first conductive terminal 21 from being peeled off.

Similarly, referring to FIG. 23, it is understandable to those skilled in the art that in order to increase the retaining force between the second conductive terminal 22 and the second insulating block 42, and reduce the risk of loosening between the two, the second conductive terminal 222 may also include a second retaining portion 2210 connected to the third conductive pad 221 and a second fixing portion 2220 connected to the fourth conductive pad 222. In the illustrated embodiment of the present disclosure, the second retaining portion 2210 and the third conductive pad 221 are in a step shape. That is, the second retaining portion 2210 and the third conductive pad 221 are not in a same plane. As a result, although the third conductive pad 221 needs to be exposed on the second surface 12, the second retaining portion 2210 may still be embedded and fixed in the insulating body 1 to increase the retaining force. Based on the same design concept, the insulating body 1 can also add a second retaining portion of a raised feature to cover the lower surface of the corresponding portion of the second conductive terminal 22 to increase the retention force and prevent the second conductive terminal 22 from being peeled off. Of course, it is understandable to those skilled in the art that the shapes of the second retaining portion 2210 and the second fixing portion 2220 can be flexibly adjusted as needed, for example, bent in an inclined or arced surface. The second fixing portion 2220 and the fourth conductive pad 222 are in a step shape. That is, the second fixing portion 2220 and the fourth conductive pad 222 are not in a same plane. As a result, although the fourth conductive pad 222 needs to be exposed on the second surface 12, the second fixing portion 2220 can still be embedded and fixed in the insulating body 1 to increase the retention force. Based on the same design concept, the insulating body 1 can also add a fourth retaining portion of a raised feature to cover the lower surface of the corresponding portion of the second conductive terminal 22 to increase the retention force and prevent the second conductive terminal 22 from being peeled off.

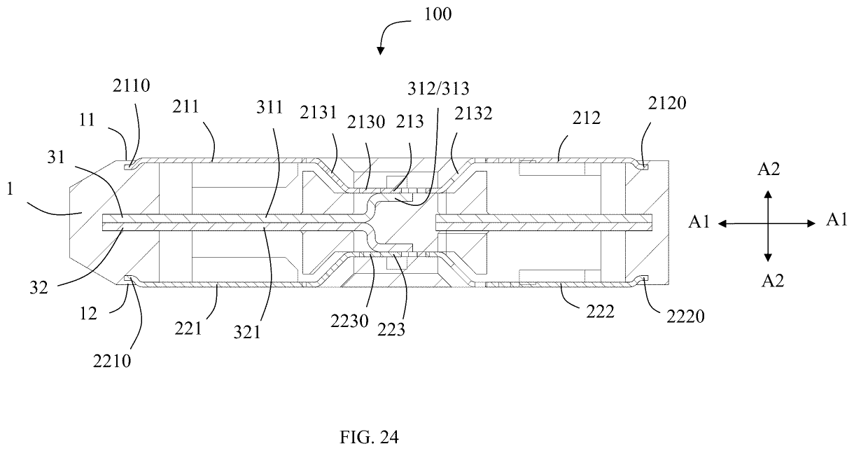

Referring to FIG. 24, the terminal module in an eighth embodiment of the present disclosure is similar to the terminal module in the second embodiment shown in FIG. 13. The main difference between the two is that in the terminal module in the eighth embodiment of the present disclosure, the first conductive terminal 21 may further include a first retaining portion 2110 connected to the first conductive pad 211 and a first fixing portion 2120 connected to the second conductive pad 212. The second conductive terminal 22 may further include a second retaining portion 2210 connected to the third conductive pad 221 and a second fixing portion 2220 connected to the fourth conductive pad 222. The structures and functions of the first retaining portion 2110, the first fixing portion 2120, the second retaining portion 2210 and the second fixing portion 2220 are the same as those in FIG. 23, which will not be described in detail in the present disclosure.

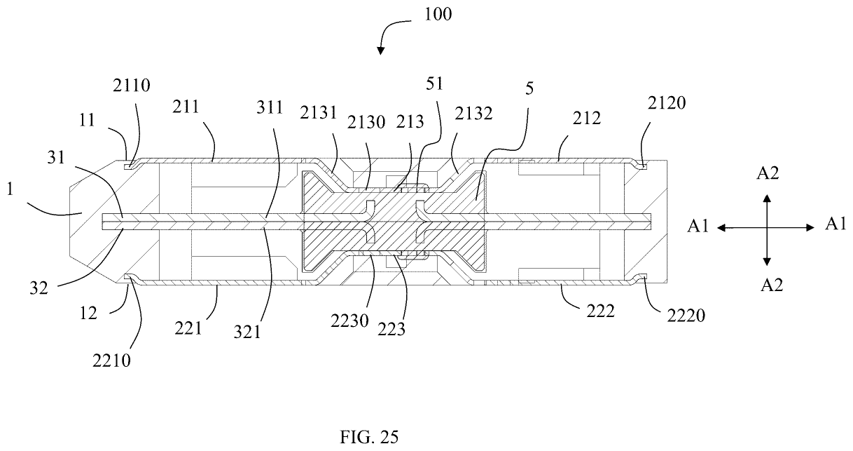

Referring to FIG. 25, the terminal module in a ninth embodiment of the present disclosure is similar to the terminal module in the third embodiment shown in FIG. 14. The main difference between the two is that, in the terminal module in the ninth embodiment of the present disclosure, the first conductive terminal 21 may further include a first retaining portion 2110 connected to the first conductive pad 211 and a first fixing portion 2120 connected to the second conductive pad 212. The second conductive terminal 22 may further include a second retaining portion 2210 connected to the third conductive pad 221, and a second fixing portion 2220 connected to the fourth conductive pad 222. The structures and functions of the first retaining portion 2110, the first fixing portion 2120, the second retaining portion 2210, and the second fixing portion 2220 are the same as those in FIG. 23, which will not be described in detail in the present disclosure.

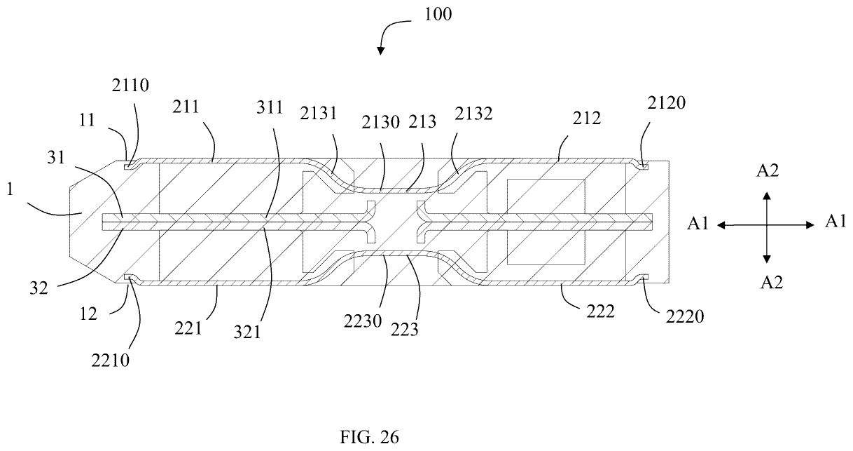

Referring to FIG. 26, the terminal module in a tenth embodiment of the present disclosure is similar to the terminal module in the fifth embodiment shown in FIG. 16. The main difference between the two is that, in the terminal module in the tenth embodiment of the present disclosure, the first conductive terminal 21 may further include a first retaining portion 2110 connected to the first conductive pad 211 and a first fixing portion 2120 connected to the second conductive pad 212. The second conductive terminal 22 may further include a second retaining portion 2210 connected to the third conductive pad 221, and a second fixing portion 2220 connected to the fourth conductive pad 222. The structures and functions of the first retaining portion 2110, the first fixing portion 2120, the second retaining portion 2210 and the second fixing portion 2220 are the same as those in FIG. 23, which will not be described in detail in the present disclosure.

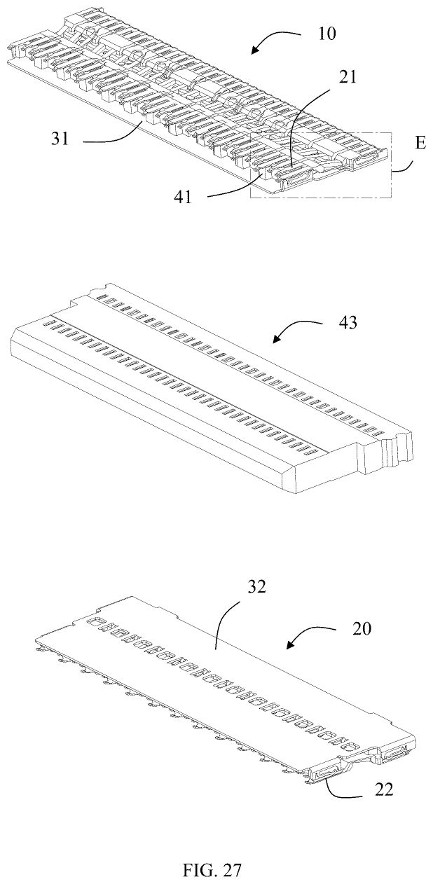

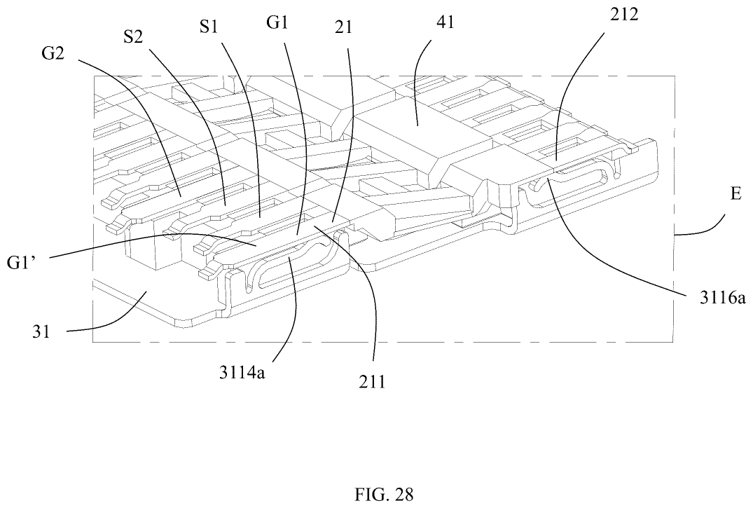

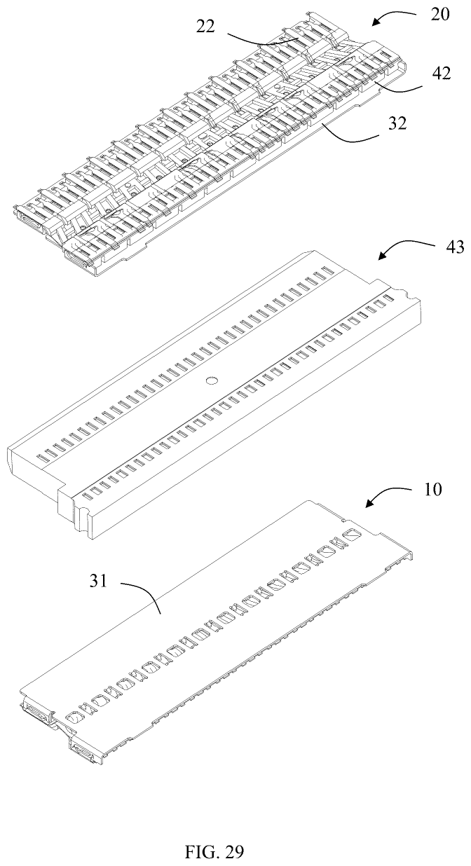

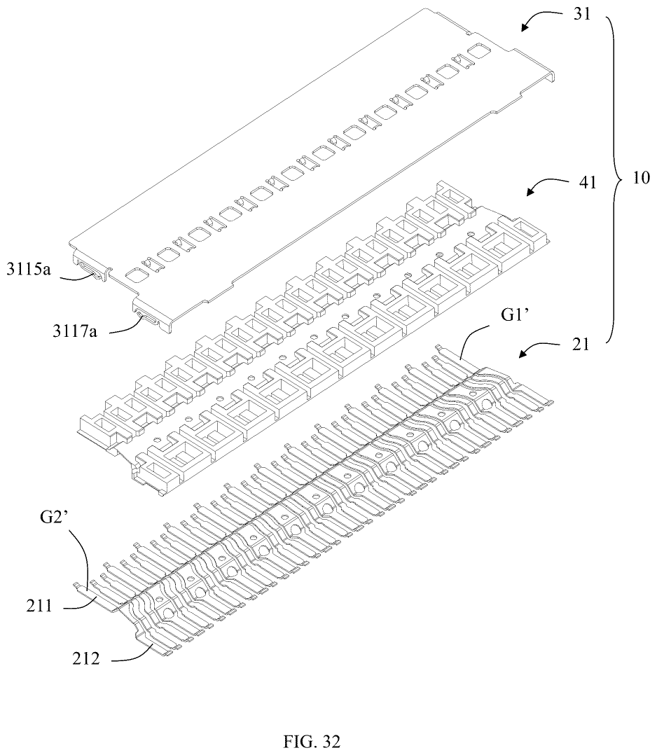

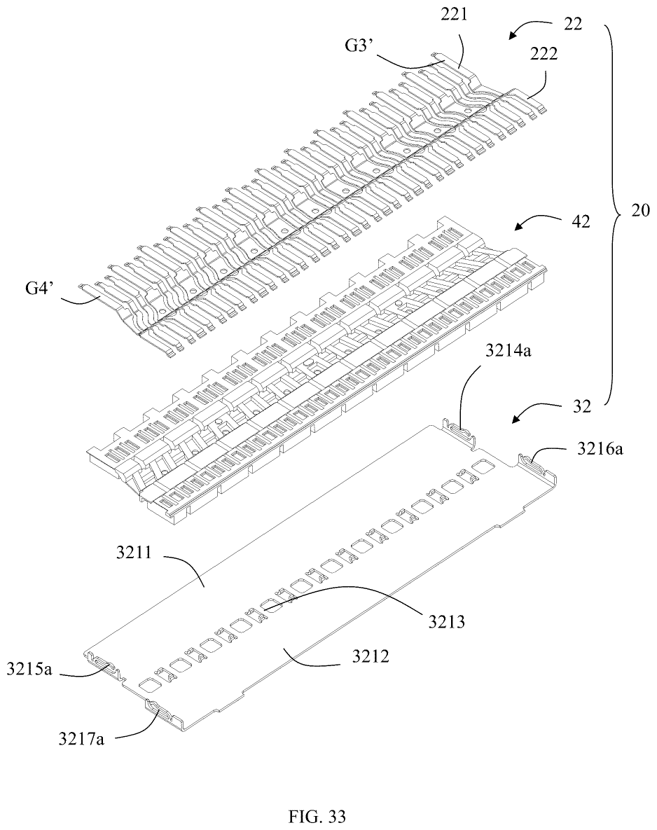

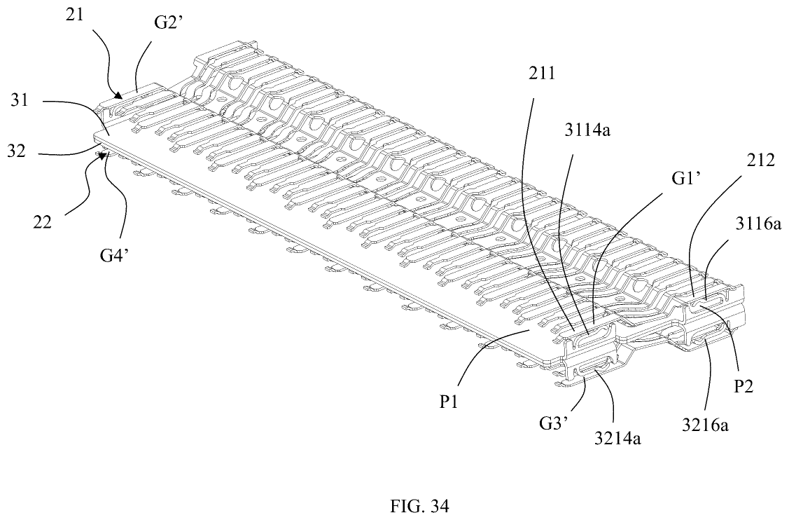

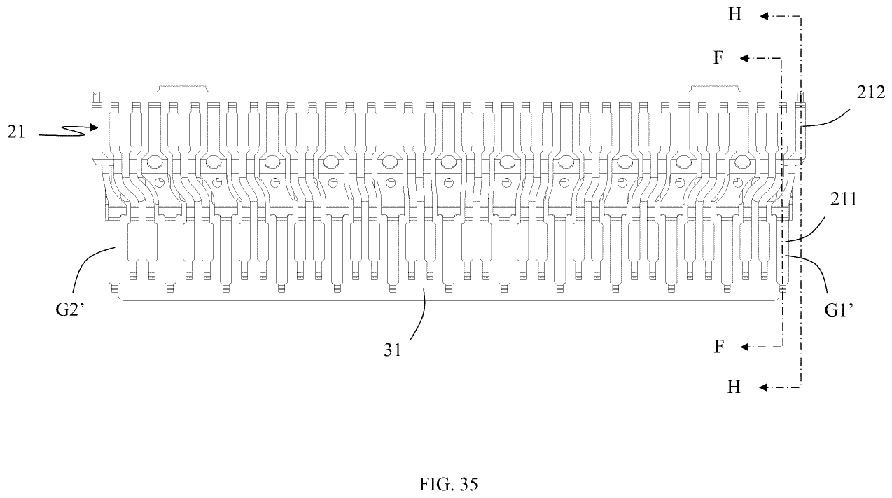

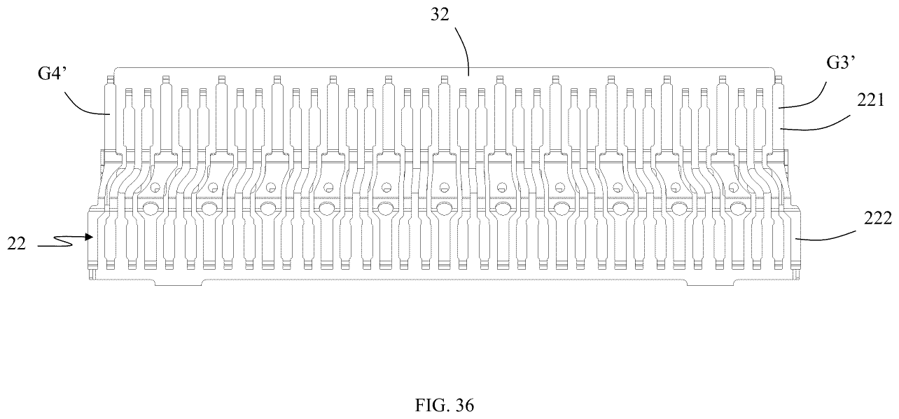

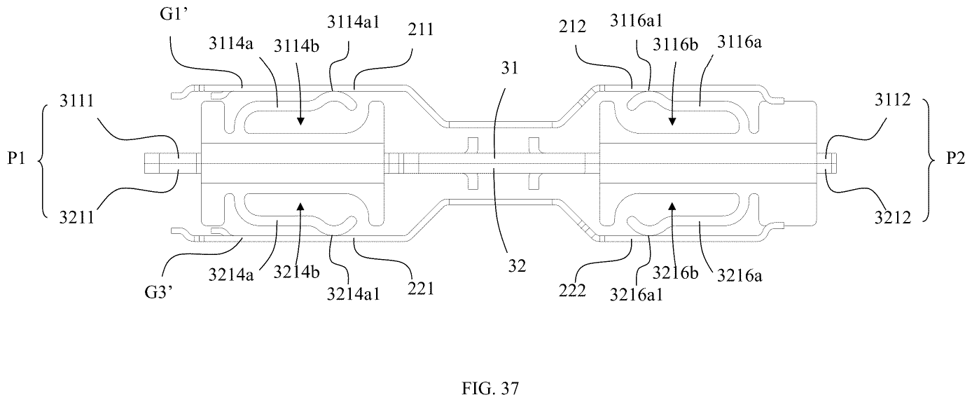

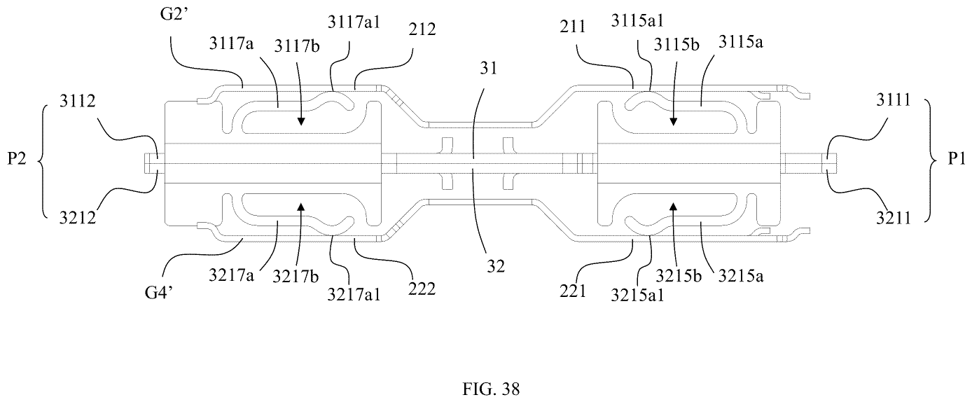

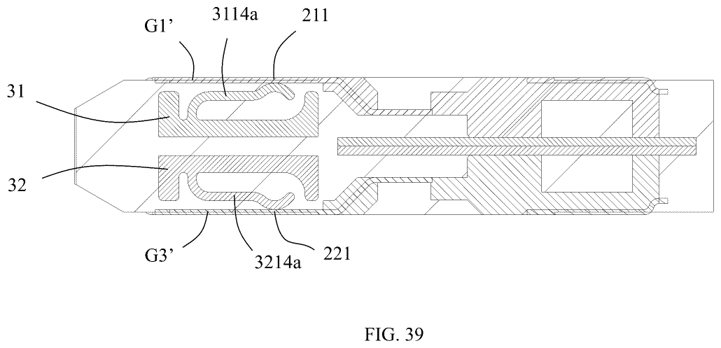

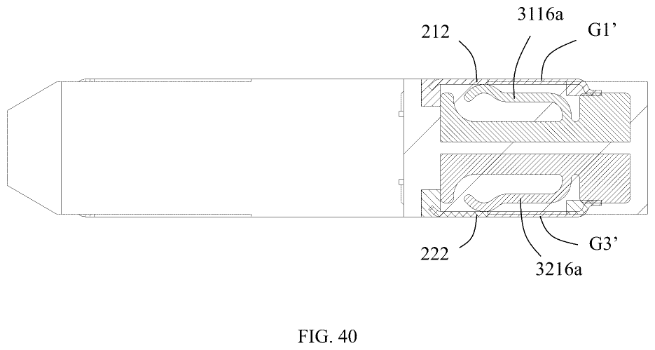

Referring to FIG. 27 to FIG. 40, an eleventh embodiment illustrated in the present disclosure discloses a terminal module 100, which is similar to the terminal module 100 disclosed in the seventh embodiment. The terminal module 100 in the eleventh embodiment of the present disclosure includes a plurality of first conductive terminals 21, an insulating body 1, and a first shielding piece 31. More specifically, in the eleventh embodiment of the present disclosure, the terminal module 100 further includes a plurality of second conductive terminals 22 and a second shielding piece 32. Besides, for ease of assembly, the terminal module 100 includes a first terminal assembly 10 and a second terminal assembly 20. The first terminal assembly 10 includes a first insulating block 41 which is fixed together with the first conductive terminals 21 and the first shielding piece 31 to form an integrated unit. Similarly, the second terminal assembly 20 includes a second insulating block 42 which is fixed together with the second conductive terminals 22 and the second shielding piece 32 to form an integrated unit. The terminal module 100 further includes a third insulating block 43 that is secondarily molded onto the first terminal assembly 10 and the second terminal assembly 20. It is understandable to those skilled in the art that after the third insulating block 43 is molded onto the first insulating block 41 and the second insulating block 42. The third insulating block 43, the first insulating block 41 and the second insulating block 42 are combined into one entity and collectively referred to as the insulating body 1.

In the eleventh embodiment illustrated in the present disclosure, the first conductive terminal 21, the first insulating block 41, the second conductive terminal 22, the second insulating block 42 and the third insulating block 43 of the terminal module 100 are identical to those in the seventh embodiment, and thus no further description is provided here.

Furthermore, in the eleventh embodiment of the terminal module 100, the first conductive terminals 21 include a first outer ground terminal G1′ and a second outer ground terminal G2′. In the illustrated embodiment of the present disclosure, the first outer ground terminal G1′ and the second outer ground terminal G2′ are the two outermost terminals of the first conductive terminal 21, respectively, along the third direction A3-A3.

The main difference between the terminal module 100 in the eleventh embodiment of the present disclosure and that in the seventh embodiment lies in the specific structures of the first shielding piece 31 and the second shielding piece 32. Below, only the first shielding piece 31 and the second shielding piece 32 will be described in detail.

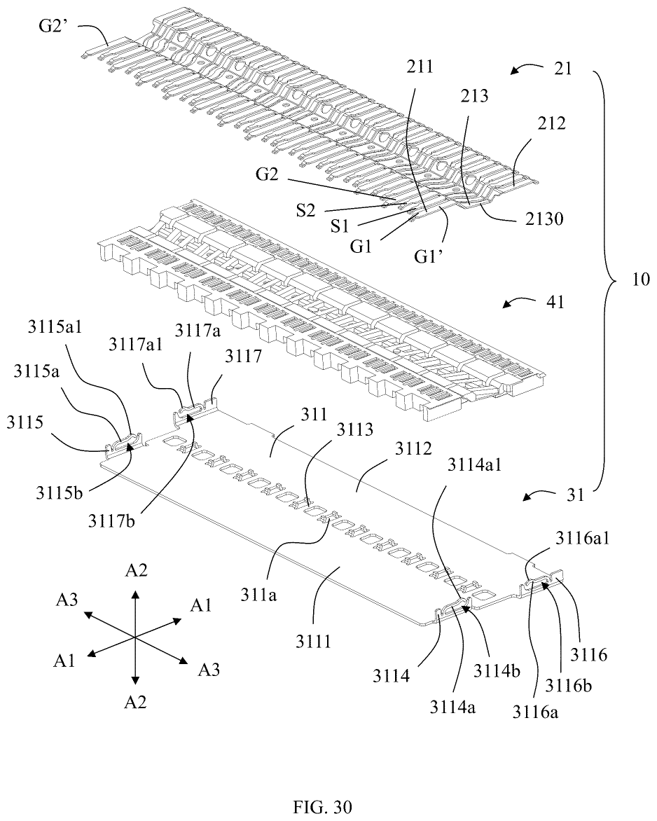

Referring to FIG. 27 to FIG. 40, in the eleventh embodiment of the terminal module 100 of the present disclosure, the first shielding piece 31 is made of a metal material, and includes a first plate portion 311 which is at least partially embedded in the insulating body 1. The first embedded portion 2130 is positioned between the first conductive pad 211 and the first plate portion 311 along the second direction A2-A2. With this arrangement, the first embedded portion 2130 can function similarly to a conductive path on a printed circuit board. As shown in FIG. 30, in the illustrated embodiment of the present disclosure, the first plate portion 311 extends forwardly beyond the first conductive pad 211 along the first direction A1-A1, and extends rearwardly beyond the second conductive pad 212 along the first direction A1-A1, providing improved shielding effectiveness along the entire length of the first conductive pad 211 and the second conductive pad 212.

Specifically, the first shielding piece 31 includes a first shielding portion 3111 corresponding to the first conductive pads 211, a second shielding portion 3112 corresponding to the second conductive pads 212, a first connecting piece 3113 connecting the first shielding portion 3111 and the second shielding portion 3112, a first side wall portion 3114 bent from one side of the first shielding portion 3111, a second side wall portion 3115 bent from another side of the first shielding portion 3111, a third side wall portion 3116 bent from one side of the second shielding portion 3112, and a fourth side wall portion 3117 bent from another side of the second shielding portion 3112. The first side wall portion 3114 and the third side wall portion 3116 are located on one side of the first plate portion 311, while the second side wall portion 3115 and the fourth side wall portion 3117 are located on another side of the first plate portion 311. The first shielding portion 3111, the second shielding portion 3112, and the first connecting piece 3113 are provided on the first plate portion 311. In the illustrated embodiment of the present disclosure, the first shielding piece 31 is of a one-piece configuration to reduce manufacturing difficulty, enhance structural strength, and improve shielding effectiveness. In other words, the first shielding portion 3111, the second shielding portion 3112, the first connecting piece 3113, the first side wall portion 3114, the second side wall portion 3115, the third side wall portion 3116 and the fourth side wall portion 3117 are integrally formed.

In the illustrated embodiment of the present disclosure, both the first side wall portion 3114 and the third side wall portion 3116 are perpendicular to the first shielding portion 3111 and the second shielding portion 3112. The first shielding portion 3111 and the second shielding portion 3112 lie in a first plane (e.g., a horizontal plane) formed by the first direction A1-A1 and the third direction A3-A3, while the first side wall portion 3114 and the third side wall portion 3116 each lies in a second plane (e.g., a vertical plane) formed by the first direction A1-A1 and the second direction A2-A2. The first side wall portion 3114 and the third side wall portion 3116 are spaced apart along the first direction A1-A1, such that they can avoid mutual interference during their respective bending processes. In the illustrated embodiment of the present disclosure, the first side wall portion 3114 and the third side wall portion 3116 are staggered along the first direction A1-A1 to correspond to the first conductive pads 211 and the second conductive pads 212, respectively.

In the illustrated embodiment of the present disclosure, the first side wall portion 3114 is provided with at least one first abutting elastic arm 3114a and at least one first accommodating groove 3114b corresponding to the first abutting elastic arm 3114a. In the illustrated embodiment of the present disclosure, the first abutting elastic arm 3114a is integrally extended (e.g., stamped) from the first side wall portion 3114. The first abutting elastic arm 3114a is of a cantilever-shaped configuration, and extends from front to back along the first direction A1-A1. The first abutting elastic arm 3114a is provided with a first abutting portion 3114a1 approximately located at a free end thereof. In the illustrated embodiment of the present disclosure, the first abutting portion 3114a1 is in a raised arc shape. The first accommodating groove 3114b is located below the first abutting elastic arm 3114a to provide a space for a downward deformation of the first abutting elastic arm 3114a.

Similarly, in the illustrated embodiment of the present disclosure, the second side wall portion 3115 is provided with at least one second abutting elastic arm 3115a and at least one second accommodating groove 3115b corresponding to the second abutting elastic arm 3115a. In the illustrated embodiment of the present disclosure, the second abutting elastic arm 3115a is integrally extended (e.g., stamped) from the second side wall portion 3115. The second abutting elastic arm 3115a is of a cantilever-shaped configuration, and extends from front to back along the first direction A1-A1. The second abutting elastic arm 3115a is provided with a second abutting portion 3115a1 approximately located at a free end thereof. In the illustrated embodiment of the present disclosure, the second abutting portion 3115a1 is in a raised arc shape. The second accommodating groove 3115b is located below the second abutting elastic arm 3115a to provide a space for a downward deformation of the second abutting elastic arm 3115a.

In the illustrated embodiment of the present disclosure, the third side wall portion 3116 is provided with at least one third abutting elastic arm 3116a and at least one third accommodating groove 3116b corresponding to the third abutting elastic arm 3116a. In the illustrated embodiment of the present disclosure, the third abutting elastic arm 3116a is integrally extended (e.g., stamped) from the third side wall portion 3116. The third abutting elastic arm 3116a is of a cantilever-shaped configuration, and extends from back to front along the first direction A1-A1. The third abutting elastic arm 3116a is provided with a third abutting portion 3116a1 approximately located at a free end thereof. In the illustrated embodiment of the present disclosure, the third abutting portion 3116a1 is in a raised arc shape. The third accommodating groove 3116b is located below the third abutting elastic arm 3116a to provide a space for a downward deformation of the third abutting elastic arm 3116a. An extending direction of the third abutting elastic arm 3116a is opposite to that of the first abutting elastic arm 3114a, bringing the third abutting portion 3116a1 and the first abutting portion 3114a1 as close to the center as possible, thereby improving the contact effect between the first shielding piece 31 and the corresponding first conductive terminals 21. The third abutting elastic arm 3116a and the first abutting elastic arm 3114a are staggered along the first direction A1-A1.

Similarly, in the illustrated embodiment of the present disclosure, the fourth side wall portion 3117 is provided with at least one fourth abutting elastic arm 3117a and at least one fourth accommodating groove 3117b corresponding to the fourth abutting elastic arm 3117a. In the illustrated embodiment of the present disclosure, the fourth abutting elastic arm 3117a is integrally extended (e.g., stamped) from the fourth side wall portion 3117. The fourth abutting elastic arm 3117a is of a cantilever-shaped configuration, and extends from the rear to the front along the first direction A1-A1. The fourth abutting elastic arm 3117a is provided with a fourth abutting portion 3117a1 approximately located at a free end thereof. In the illustrated embodiment of the present disclosure, the fourth abutting portion 3117a1 is in a raised arc shape. The fourth accommodating groove 3117b is located below the fourth abutting elastic arm 3117a to provide a space for a downward deformation of the fourth abutting elastic arm 3117a. An extending direction of the fourth abutting elastic arm 3117a is opposite to that of the second abutting elastic arm 3115a, bringing the fourth abutting portion 3117a1 and the second abutting portion 3115a1 as close to the center as possible, thereby improving the contact effect between the first shielding piece 31 and the corresponding first conductive terminals 21. The fourth abutting elastic arm 3117a and the second abutting elastic arm 3115a are staggered along the first direction A1-A1.

Besides, the first connecting piece 3113 of the first plate portion 311 defines a plurality of first openings 311a that extend through the first connecting piece 3113 along the second direction A2-A2. The first shielding piece 31 is fixed to the first insulating block 41 by assembly, or the first insulating block 41 is injection-molded on the first shielding piece 31.

In the illustrated embodiment of the present disclosure, the first abutting portion 3114a1 of the first abutting elastic arm 3114a is in elastic contact with the first conductive pad 211 of the first outer ground terminal G1′. The second abutting portion 3115a1 of the second abutting elastic arm 3115a is in elastic contact with the first conductive pad 211 of the second outer ground terminal G2′. The third abutting portion 3116a1 of the third abutting elastic arm 3116a is in elastic contact with the second conductive pad 212 of the first outer ground terminal G1′. The fourth abutting portion 3117a1 of the fourth abutting elastic arm 3117a is in elastic contact with the second conductive pad 212 of the second outer ground terminal G2′. As a result, this configuration improves the grounding shielding effect.

Besides, in the illustrated embodiment of the present disclosure, both the first shielding portion 3111 and the second shielding portion 3112 are complete, meaning that neither the first shielding portion 3111 nor the second shielding portion 3112 has any openings extending through them along the second direction A2-A2. This enhances the shielding effectiveness for the first conductive pads 211 and the second conductive pads 212, reduces signal crosstalk, and improves signal integrity.

Furthermore, in the eleventh embodiment of the terminal module 100, the second conductive terminal 22 includes a third outer ground terminal G3′ and a fourth outer ground terminal G4′. In the illustrated embodiment of the present disclosure, the third outer ground terminal G3′ and the fourth outer ground terminal G4′ are the two outermost terminals of the second conductive terminal 22, respectively, along the third direction A3-A3.

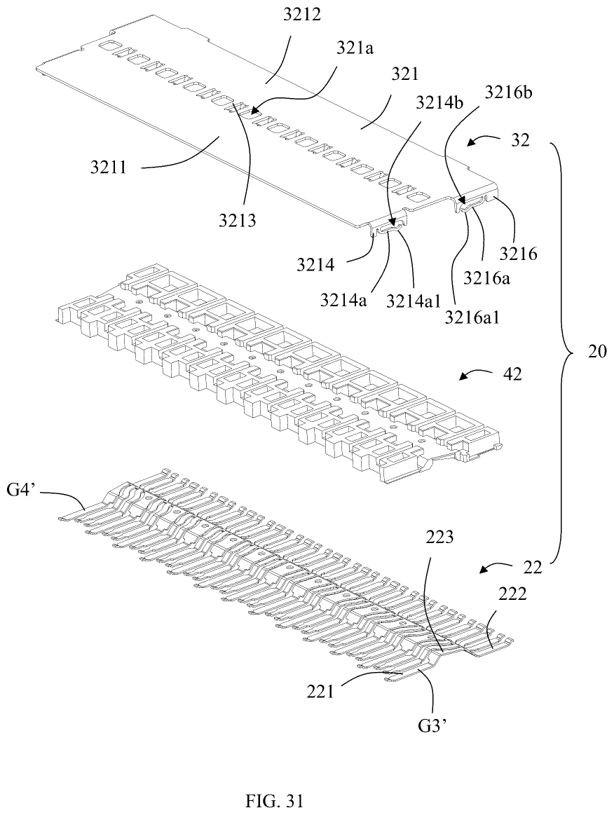

In the eleventh embodiment of the terminal module 100, as shown in FIG. 27 to FIG. 40, the second shielding piece 32 is made of a metal material, and includes a second plate portion 321 that is at least partially embedded in the insulating body 1. The second embedded portion 2230 is positioned along the second direction A2-A2 between the third conductive plates 221 and the second plate portion 321. With this arrangement, the second embedded portion 2230 can function similarly to a conductive path on a printed circuit board. As illustrated in FIG. 31, in the illustrated embodiment of the present disclosure, the second plate portion 321 extends forwardly beyond the third conductive pad 221 along the first direction A1-A1, and extends rearwardly beyond the fourth conductive pad 222 along the first direction A1-A1, thereby providing effective shielding along the entire length of both the third conductive pad 221 and the fourth conductive pad 222.

Specifically, the second shielding piece 32 includes a third shielding portion 3211 corresponding to the third conductive pad 221, a fourth shielding portion 3212 corresponding to the fourth conductive pad 222, a second connecting piece 3213 connecting the third shielding portion 3211 and the fourth shielding portion 3212, a fifth side wall portion 3214 bent from one side of the third shielding portion 3211, a sixth side wall portion 3215 bent from another side of the third shielding portion 3211, a seventh side wall portion 3216 bent from one side of the fourth shielding portion 3212, and an eighth side wall portion 3217 bent from another side of the fourth shielding portion 3212. The fifth side wall portion 3214 and the seventh side wall portion 3216 are located on one side of the second plate portion 321, while the sixth side wall portion 3215 and the eighth side wall portion 3217 are located on another side of the second plate portion 321. The third shielding portion 3211, the fourth shielding portion 3212, and the second connecting piece 3213 are arranged on the second plate portion 321. In the illustrated embodiment of the present disclosure, the second shielding piece 32 is of a one-piece configuration to reduce manufacturing difficulty, enhance structural strength, and improve shielding effectiveness. In other words, the third shielding portion 3211, the fourth shielding portion 3212, the second connecting piece 3213, the fifth side wall portion 3214, the sixth side wall portion 3215, the seventh side wall portion 3216 and the eighth side wall portion 3217 are integrally formed.

In the illustrated embodiments of the present disclosure, both the fifth side wall portion 3214 and the seventh side wall portion 3216 are perpendicular to the third shielding portion 3211 and the fourth shielding portion 3212. The third shielding portion 3211 and the fourth shielding portion 3212 lie in a first plane (e.g., a horizontal plane) formed by the first direction A1-A1 and the third direction A3-A3, while the fifth side wall portion 3214 and the seventh side wall portion 3216 each lies in a second plane (e.g., a vertical plane) formed by the first direction A1-A1 and the second direction A2-A2. The fifth side wall portion 3214 and the seventh side wall portion 3216 are spaced apart along the first direction A1-A1, such that they can avoid mutual interference during their respective bending processes. In the illustrated embodiments of the present disclosure, the fifth side wall portion 3214 and the seventh side wall portion 3216 are staggered along the first direction A1-A1 to correspond to the third conductive pads 221 and the fourth conductive pads 222, respectively.

In the illustrated embodiment of the present disclosure, the fifth side wall portion 3214 is provided with at least one fifth abutting elastic arm 3214a and at least one fifth accommodating groove 3214b corresponding to the fifth abutting elastic arm 3214a. In the illustrated embodiment of the present disclosure, the fifth abutting elastic arm 3214a is integrally extended (e.g., stamped) from the fifth side wall portion 3214. The fifth abutting elastic arm 3214a is of a cantilever-shaped configuration, and extends from front to back along the first direction A1-A1. The fifth abutting elastic arm 3214a is provided with a fifth abutting portion 3214a1 approximately located at a free end thereof. In the illustrated embodiment of the present disclosure, the fifth abutting portion 3214a1 is in a recessed arc shape. The fifth accommodating groove 3214b is located above the fifth abutting elastic arm 3214a to provide a space for an upward deformation of the fifth abutting elastic arm 3214a.

Similarly, in the illustrated embodiment of the present disclosure, the sixth side wall portion 3215 is provided with at least one sixth abutting elastic arm 3215a and at least one sixth accommodating groove 3215b corresponding to the sixth abutting elastic arm 3215a. In the illustrated embodiment of the present disclosure, the sixth abutting elastic arm 3215a is integrally extended (e.g., stamped) from the sixth side wall portion 3215. The sixth abutting elastic arm 3215a is of a cantilever-shaped configuration, and extends from front to back along the first direction A1-A1. The sixth abutting elastic arm 3215a is provided with a sixth abutting portion 3215a1 approximately located at a free end thereof. In the illustrated embodiment of the present disclosure, the sixth abutting portion 3215a1 is in a recessed arc shape. The sixth accommodating groove 3215b is located above the sixth abutting elastic arm 3215a to provide a space for an upward deformation of the sixth abutting elastic arm 3215a.

In the illustrated embodiment of the present disclosure, the seventh side wall portion 3216 is provided with at least one seventh abutting elastic arm 3216a and at least one seventh accommodating groove 3216b corresponding to the seventh abutting elastic arm 3216a. In the illustrated embodiment of the present disclosure, the seventh abutting elastic arm 3216a is integrally extended (e.g., stamped) from the seventh side wall portion 3216. The seventh abutting elastic arm 3216a is of a cantilever-shaped configuration, and extends from the rear to the front along the first direction A1-A1. The seventh abutting elastic arm 3216a is provided with a seventh abutting portion 3216a1 approximately located at a free end thereof. In the illustrated embodiment of the present disclosure, the seventh abutting portion 3216a1 is in a recessed arc shape. The seventh accommodating groove 3216b is located above the seventh abutting elastic arm 3216a to provide a space for an upward deformation of the seventh abutting elastic arm 3216a. An extending direction of the seventh abutting elastic arm 3216a is opposite to that of the fifth abutting elastic arm 3214a, bringing the seventh abutting portion 3216a1 and the fifth abutting portion 3214a1 closer to the center, thereby improving the contact effect between the second shielding piece 32 and the corresponding second conductive terminal 22. The seventh abutting elastic arm 3216a and the fifth abutting elastic arm 3214a are staggered along the first direction A1-A1.

Similarly, in the illustrated embodiment of the present disclosure, the eighth side wall portion 3217 is provided with at least one eighth abutting elastic arm 3217a and at least one eighth accommodating groove 3217b corresponding to the eighth abutting elastic arm 3217a. In the illustrated embodiment of the present disclosure, the eighth abutting elastic arm 3217a is integrally extended (e.g., stamped) from the eighth side wall portion 3217. The eighth abutting elastic arm 3217a is of a cantilever-shaped configuration, and extends from back to front along the first direction A1-A1. The eighth abutting elastic arm 3217a is provided with an eighth abutting portion 3217a1 approximately located at a free end thereof. In the illustrated embodiment of the present disclosure, the eighth abutting portion 3217a1 is in a recessed arc shape. The eighth accommodating groove 3217b is located above the eighth abutting elastic arm 3217a to provide a space for an upward deformation of the eighth abutting elastic arm 3217a. An extending direction of the eighth abutting elastic arm 3217a is opposite to that of the sixth abutting elastic arm 3215a, bringing the eighth abutting portion 3217a1 and the sixth abutting portion 3215a1 as close to the center as possible, thereby improving the contact effectiveness between the second shielding piece 32 and the corresponding second conductive terminal 22. The eighth abutting elastic arm 3217a and the sixth abutting elastic arm 3215a are staggered along the first direction A1-A1.

Besides, the second connecting piece 3213 of the second plate portion 321 defines a plurality of second openings 321a that extend through the second connecting piece 3213 along the second direction A2-A2. The second shielding piece 32 is fixed to the second insulating block 42 by assembly, or the second insulating block 42 is injection-molded on the second shielding piece 32.

In the illustrated embodiment of the present disclosure, the fifth abutting portion 3214a1 of the fifth abutting elastic arm 3214a is in elastic contact with the third conductive pad 221 of the third outer ground terminal G3′. The sixth abutting portion 3215a1 of the sixth abutting elastic arm 3215a is in elastic contact with the third conductive pad 221 of the fourth outer ground terminal G4′. The seventh abutting portion 3216a1 of the seventh abutting elastic arm 3216a is in elastic contact with the fourth conductive pad 222 of the third outer ground terminal G3′. The eighth abutting portion 3217a1 of the eighth abutting elastic arm 3217a is in elastic contact with the fourth conductive pad 222 of the fourth outer ground terminal G4′. As a result, this configuration improves the grounding shielding effect.

Besides, in the illustrated embodiment of the present disclosure, both the third shielding portion 3211 and the fourth shielding portion 3212 are complete, meaning that neither the third shielding portion 3211 nor the fourth shielding portion 3212 has any openings along the second direction A2-A2 that extend through them. This enhances the shielding effect on the third conductive pads 221 and the fourth conductive pads 222, reduces signal crosstalk, and improves signal integrity.

In the illustrated embodiment of the present disclosure, the first plate portion 311 of the first shielding piece 31 is in contact with the second plate portion 321 of the second shielding piece 32. In the illustrated embodiment of the present disclosure, the first plate portion 311 of the first shielding piece 31 and the second plate portion 321 of the second shielding piece 32 are adhered to each other along the second direction A2-A2. The shape and size of the first shielding portion 3111 of the first shielding piece 31 are the same as those of the third shielding portion 3211 of the second shielding piece 32. The first shielding portion 3111 of the first shielding piece 31 and the third shielding portion 3211 of the second shielding piece 32 together form a first shielding layer P1 located between the first conductive pads 211 of the first conductive terminals 21 and the third conductive pads 221 of the second conductive terminals 22. As a whole, the first shielding layer P1 is at least free of any openings extending through it along the second direction A2-A2, thereby reducing signal crosstalk between the first conductive pads 211 of the first conductive terminals 21 and the third conductive pads 221 of the second conductive terminals 22.

Similarly, the shape and size of the second shielding portion 3112 of the first shielding piece 31 are identical to those of the fourth shielding portion 3212 of the second shielding piece 32. The first shielding portion 3111 of the first shielding piece 31 and the fourth shielding portion 3212 of the second shielding piece 32 together form a second shielding layer P2, located between the second conductive pads 212 of the first conductive terminals 21 and the fourth conductive pads 222 of the second conductive terminals 22. As a whole, the second shielding layer P2 does not have any openings that extend through it along the second direction A2-A2, thereby reducing signal crosstalk between the second conductive pads 212 of the first conductive terminals 21 and the fourth conductive pads 222 of the second conductive terminals 22.

Compared to related technologies, by providing the first side wall portion 3114, the second side wall portion 3115, the third side wall portion 3116 and the fourth side wall portion 3117 on the first shielding piece 31 of the present disclosure, and by providing the first abutting elastic arm 3114a, the second abutting elastic arm 3115a, the third abutting elastic arm 3116a and the fourth abutting elastic arm 3117a on the side wall portions, respective, it enables the first shielding portion 3111 and the second shielding portion 3112 to be of an integrated structure, thereby avoiding the need for openings on the first shielding portion 3111 and the second shielding portion 3112 that would compromise optimal shielding performance.

Similarly, by providing the fifth side wall portion 3214, the sixth side wall portion 3215, the seventh side wall portion 3216 and the eighth side wall portion 3217 on the second shielding piece 32 of the present disclosure, and by providing the fifth abutting elastic arm 3214a, the sixth abutting elastic arm 3215a, the seventh abutting elastic arm 3216a and the eighth abutting elastic arm 3217a on the side wall portions, respective, it enables the third shielding portion 3211 and the fourth shielding portion 3212 to be of an integral structure, thereby avoiding the need for openings on the third shielding portion 3211 and the fourth shielding portion 3212 that would compromise optimal shielding performance.

In the illustrated embodiment of the present disclosure, neither the first shielding portion 3111 nor the third shielding portion 3211 of the first shielding layer P1 is provided with any openings extending along the second direction A2-A2, thereby ensuring a double-layered shielding effect of the first shielding layer P1. Of course, it is understandable to those skilled in the art that one of the first shielding portion 3111 and the third shielding portion 3211 may also be provided with an opening at an overlapping position, as long as the opening is covered by the other of the first shielding portion 3111 and the third shielding portion 3211. This configuration ensures that, as a whole, the first shielding layer P1 has no openings extending through it along the second direction A2-A2, thereby also improving the shielding effect.

In the illustrated embodiments of the present disclosure, neither the second shielding portion 3112 nor the fourth shielding portion 3212 of the second shielding layer P2 is provided with any openings extending along the second direction A2-A2, thereby ensuring a double-layered shielding effect of the second shielding layer P2. Of course, it is understandable to those skilled in the art that one of the second shielding portion 3112 and the fourth shielding portion 3212 may also be provided with an opening at an overlapping position, as long as the opening is covered by the other of the second shielding portion 3112 and the fourth shielding portion 3212. This configuration ensures that, as a whole, the second shielding layer P2 does not have any openings extending along the second direction A2-A2, thereby also improving the shielding effect.

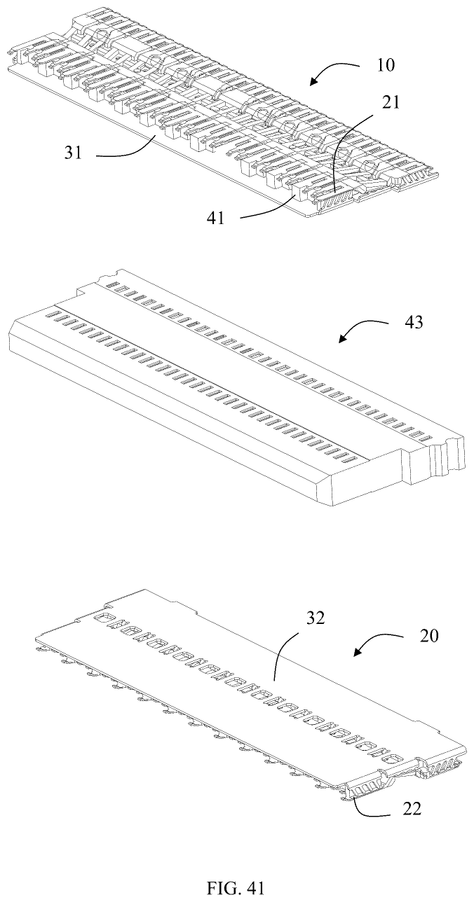

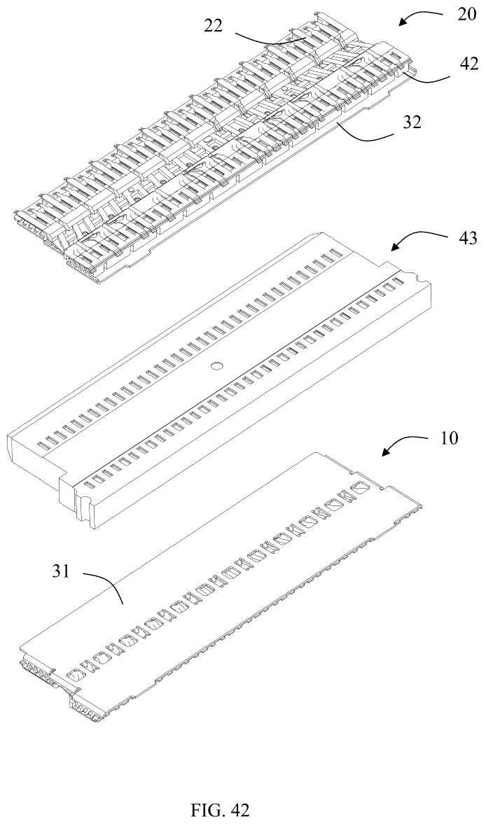

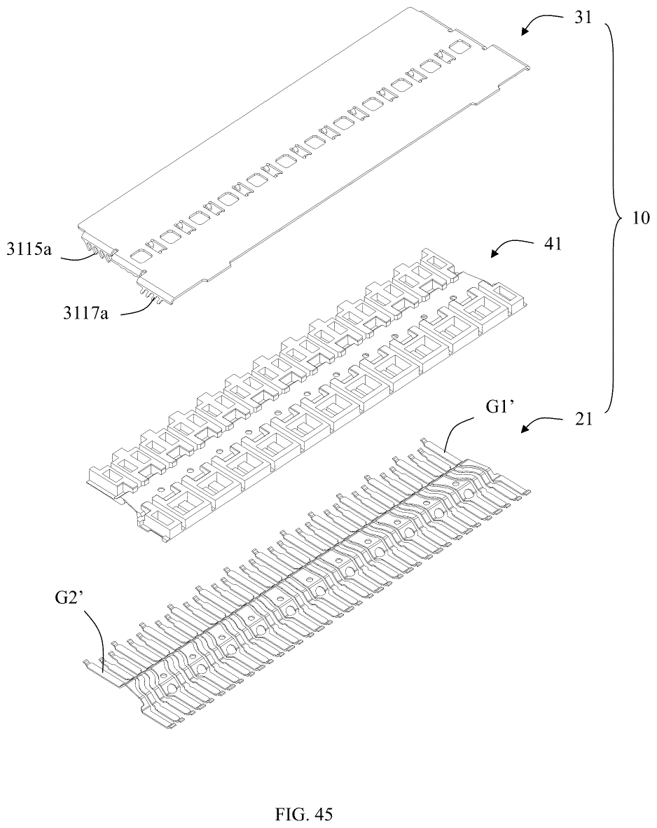

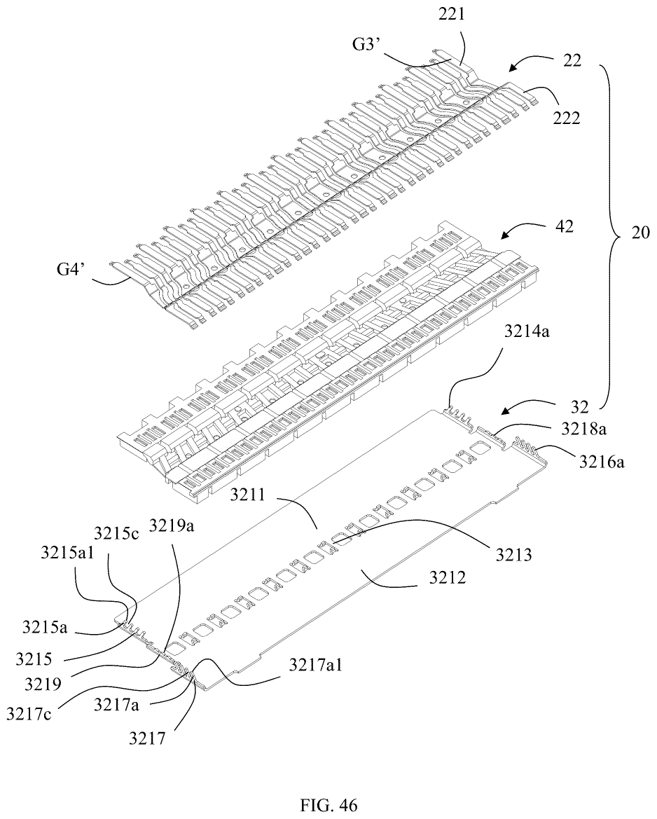

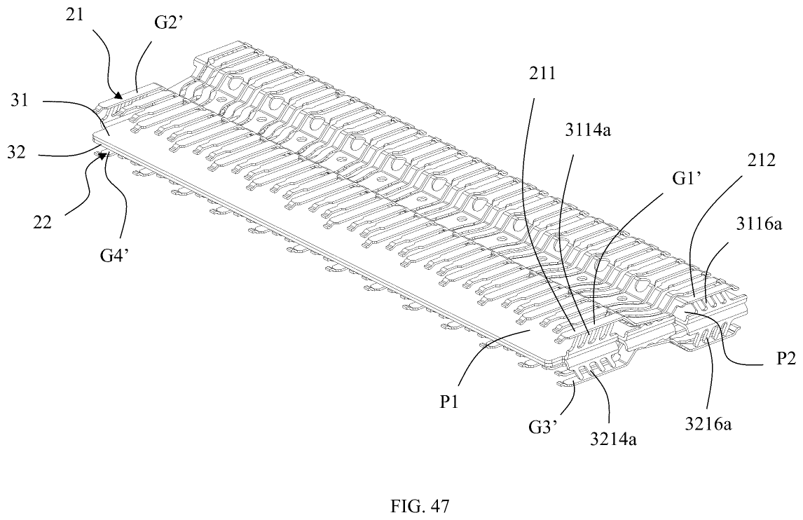

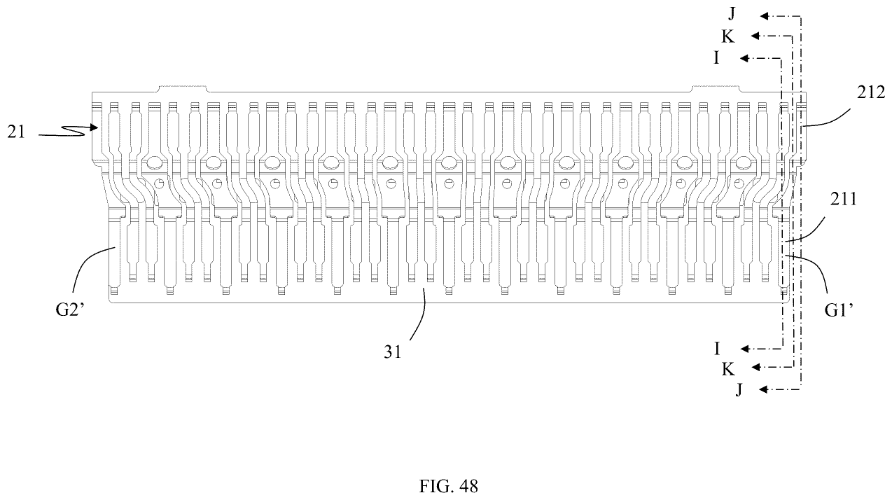

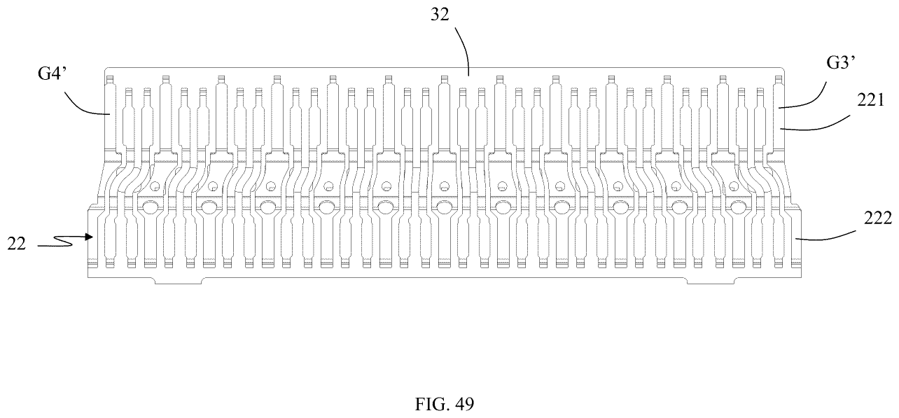

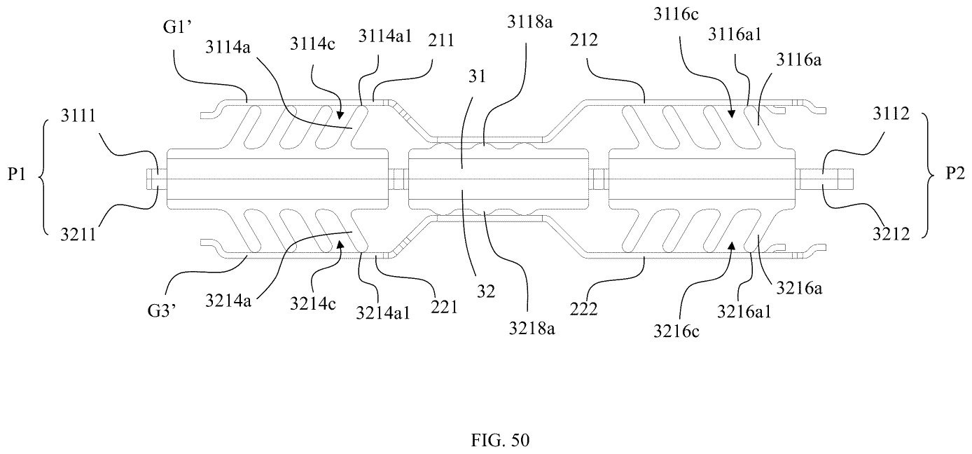

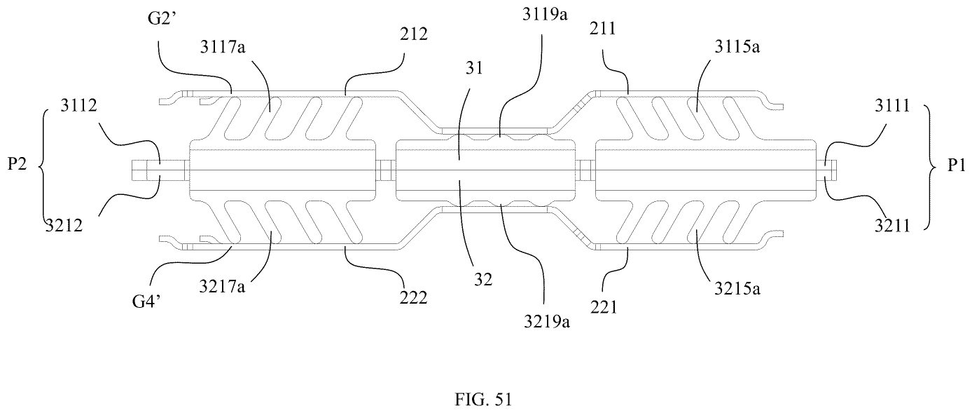

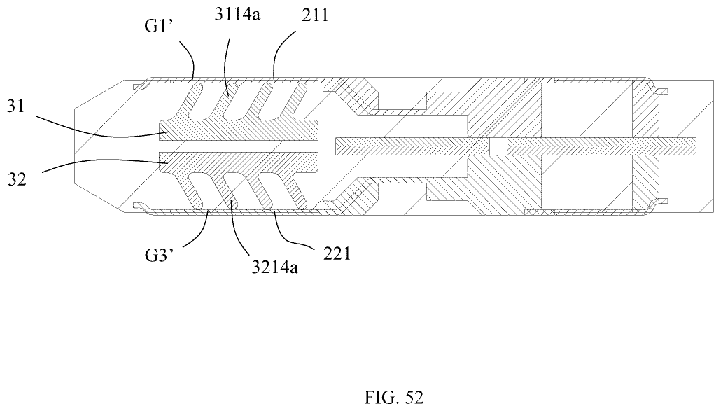

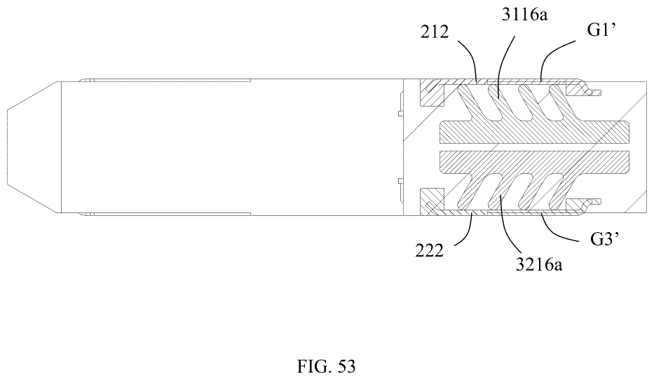

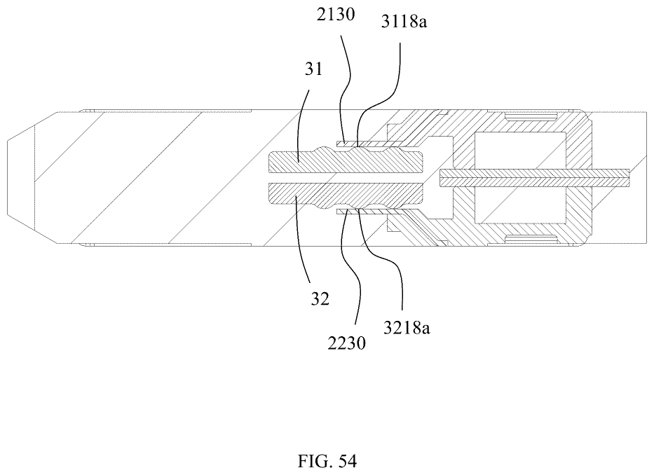

Referring to FIG. 41 to FIG. 54, a twelfth embodiment illustrated in the present disclosure discloses a terminal module 100 which is similar to the terminal module 100 disclosed in the eleventh embodiment. The main difference between the two lies in the specific structures of the first shielding piece 31 and the second shielding piece 32. Hereinafter, only the first shielding piece 31 and the second shielding piece 32 will be described in detail.

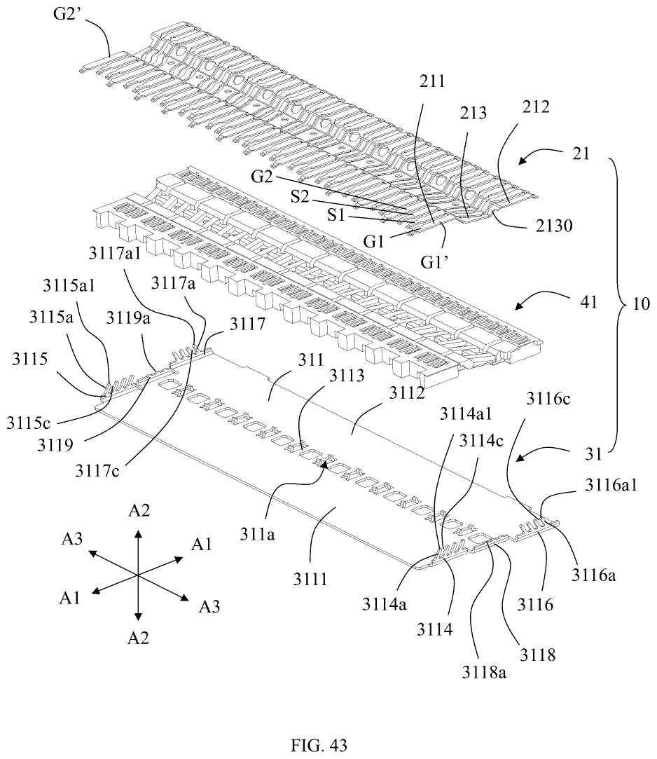

Referring to FIG. 41 to FIG. 54, in the twelfth embodiment of the terminal module 100 of the present disclosure, the first shielding piece 31 is made of a metal material, and includes a first plate portion 311 at least partially embedded in the insulating body 1. The first embedded portion 2130 is positioned between the first conductive pads 211 and the first plate portion 311 along the second direction A2-A2. With this arrangement, the first embedded portion 2130 can function similarly to a conductive path on a printed circuit board. As shown in FIG. 43, in the illustrated embodiment of the present disclosure, the first plate portion 311 extends forwardly beyond the first conductive pad 211 along the first direction A1-A1, and extends rearwardly beyond the second conductive pad 212 along the first direction A1-A1, thereby providing improved shielding effectiveness along the entire length of both the first conductive pad 211 and the second conductive pad 212.

Specifically, the first shielding piece 31 includes a first shielding portion 3111 corresponding to the first conductive pads 211, a second shielding portion 3112 corresponding to the second conductive pads 212, a first connecting piece 3113 connecting the first shielding portion 3111 and the second shielding portion 3112, a first side wall portion 3114 bent from one side of the first shielding portion 3111, a second side wall portion 3115 bent from another side of the first shielding portion 3111, a third side wall portion 3116 bent from one side of the second shielding portion 3112, a fourth side wall portion 3117 bent from another side of the second shielding portion 3112, a first end wall portion 3118 bent from one side of the first connecting piece 3113, and a second end wall portion 3119 bent from another side of the first connecting piece 3113. The first side wall portion 3114, the third side wall portion 3116 and the first end wall portion 3118 are located on one side of the first plate portion 311, while the second side wall portion 3115, the fourth side wall portion 3117 and the second end wall portion 3119 are located on another side of the first plate portion 311. The first shielding portion 3111, the second shielding portion 3112 and the first connecting piece 3113 are provided on the first plate portion 311. In the illustrated embodiment of the present disclosure, the first shielding piece 31 is of a one-piece configuration to reduce manufacturing difficulty, enhance structural strength, and improve shielding effectiveness. In other words, the first shielding portion 3111, the second shielding portion 3112, the first connecting piece 3113, the first side wall portion 3114, the second side wall portion 3115, the third side wall portion 3116, the fourth side wall portion 3117, the first end wall portion 3118 and the second end wall portion 3119 are integrally formed.

In the illustrated embodiment of the present disclosure, both the first side wall portion 3114 and the third side wall portion 3116 are perpendicular to the first shielding portion 3111 and the second shielding portion 3112. The first shielding portion 3111 and the second shielding portion 3112 lie in a first plane (e.g., a horizontal plane) formed by the first direction A1-A1 and the third direction A3-A3, while the first side wall portion 3114 and the third side wall portion 3116 each lies in a second plane (e.g., a vertical plane) formed by the first direction A1-A1 and the second direction A2-A2. The first side wall portion 3114 and the third side wall portion 3116 are spaced apart along the first direction A1-A1, such that they can avoid mutual interference during their respective bending processes. In the illustrated embodiment of the present disclosure, the first side wall portion 3114 and the third side wall portion 3116 are staggered along the first direction A1-A1 to correspond to the first conductive pad 211 and the second conductive pad 212, respectively.

In the illustrated embodiment of the present disclosure, the first side wall portion 3114 is provided with a plurality of inclined first abutting elastic arms 3114a and a plurality of first inclined slots 3114c located between every two adjacent first abutting elastic arms 3114a. In the illustrated embodiment of the present disclosure, the first abutting elastic arms 3114a are integrally extended (e.g., stamped) from the first side wall portion 3114. The first abutting elastic arms 3114a are of cantilever-shaped configurations, and extend obliquely toward the upper right. Each first abutting elastic arm 3114a is provided with a first abutting portion 3114a1 at a free end thereof. In the illustrated embodiment of the present disclosure, the first inclined slots 3114c are located beside the first abutting elastic arms 3114a to provide deformation space for the deformation of the first abutting elastic arms 3114a.

Similarly, in the illustrated embodiment of the present disclosure, the second side wall portion 3115 is provided with a plurality of inclined second abutting elastic arms 3115a and a plurality of second inclined slots 3115c located between every two adjacent second abutting elastic arms 3115a. In the illustrated embodiment of the present disclosure, the second abutting elastic arms 3115a are integrally extended (e.g., stamped) from the second side wall portion 3115. The second abutting elastic arms 3115a are of cantilever-shaped configurations, and extend obliquely toward the upper right direction. Each second abutting elastic arm 3115a is provided with a second abutting portion 3115a1 approximately at a free end thereof. In the illustrated embodiment of the present disclosure, the second inclined slots 3115c are positioned beside the second abutting elastic arms 3115a to provide deformation space for the deformation of the second abutting elastic arms 3115a.

In the illustrated embodiment of the present disclosure, the third side wall portion 3116 is provided with a plurality of inclined third abutting elastic arms 3116a and a plurality of third inclined slots 3116c located between every two adjacent third abutting elastic arms 3116a. In the illustrated embodiment of the present disclosure, the third abutting elastic arms 3116a are integrally extended (e.g., stamped) from the third side wall portion 3116. The third abutting elastic arms 3116a are of cantilever-shaped configurations, and extend obliquely toward the upper left direction. Each third abutting elastic arm 3116a is provided with a third abutting portion 3116a1 approximately located at a free end thereof. In the illustrated embodiment of the present disclosure, the third inclined slots 3116c are positioned beside the third abutting elastic arms 3116a to provide deformation space for the deformation of the third abutting elastic arms 3116a. An extending direction of the third abutting elastic arm 3116a differs from that of the first abutting elastic arm 3114a, allowing the third abutting portion 3116a1 and the first abutting portion 3114a1 to be as close to the center as possible, thereby improving the contact effect between the first shielding piece 31 and the corresponding first conductive terminals 21. The third abutting elastic arms 3116a and the first abutting elastic arms 3114a are staggered along the first direction A1-A1.

Similarly, in the illustrated embodiment of the present disclosure, the fourth side wall portion 3117 is provided with a plurality of inclined fourth abutting elastic arms 3117a and a plurality of fourth inclined slots 3117c located between every two adjacent fourth abutting elastic arms 3117a. In the illustrated embodiment of the present disclosure, the fourth abutting elastic arms 3117a are integrally extended (e.g., stamped) from the fourth side wall portion 3117. The fourth abutting elastic arms 3117a are of cantilever-shaped configurations, and extend obliquely toward the upper left. Each fourth abutting elastic arm 3117a is provided with a fourth abutting portion 3117a1 approximately at a free end thereof. In the illustrated embodiment of the present disclosure, the fourth inclined slots 3117c are located beside the fourth abutting elastic arms 3117a to provide deformation space for the deformation of the fourth abutting elastic arms 3117a. An extending direction of the fourth abutting elastic arm 3117a differs from that of the second abutting elastic arm 3115a, allowing the fourth abutting portion 3117a1 and the second abutting portion 3115a1 to approach the center as closely as possible, thereby improving the contact effect between the first shielding piece 31 and the corresponding first conductive terminals 21. The fourth abutting elastic arms 3117a and the second abutting elastic arms 3115a are staggered along the first direction A1-A1.

Besides, the first connecting piece 3113 of the first plate portion 311 defines a plurality of first openings 311a that extend through the first connecting piece 3113 along the second direction A2-A2. The first shielding piece 31 is fixed to the first insulating block 41 by assembly, or the first insulating block 41 is injection-molded on the first shielding piece 31.

The first end wall portion 3118 is provided with a plurality of approximately tooth-shaped first abutting protrusions 3118a, and the second end wall portion 3119 is provided with a plurality of approximately tooth-shaped second abutting protrusions 3119a.

In the illustrated embodiment of the present disclosure, the first abutting portion 3114a1 of the first abutting elastic arm 3114a is in elastic contact with the first conductive pad 211 of the first outer ground terminal G1'. The second abutting portion 3115a1 of the second abutting elastic arm 3115a is in elastic contact with the first conductive pad 211 of the second outer ground terminal G2′. The third abutting portion 3116a1 of the third abutting elastic arm 3116a is in elastic contact with the second conductive pad 212 of the first outer ground terminal G1′. The fourth abutting portion 3117a1 of the fourth abutting elastic arm 3117a is in elastic contact with the second conductive pad 212 of the second outer ground terminal G2′. As a result, this configuration improves the grounding shielding effect.

Besides, the first abutting protrusion 3118a is in contact with the first intermediate portion 213 of the first outer ground terminal G1′, and the second abutting protrusion 3119a is in contact with the first intermediate portion 213 of the second outer ground terminal G2′. As a result, this configuration further enhances the grounding and shielding effectiveness.

Besides, in the illustrated embodiment of the present disclosure, both the first shielding portion 3111 and the second shielding portion 3112 are complete, meaning that neither the first shielding portion 3111 nor the second shielding portion 3112 has any openings extending through them along the second direction A2-A2. This enhances the shielding effectiveness for the first conductive pads 211 and the second conductive pads 212, reduces signal crosstalk, and improves signal integrity.

Besides, in the twelfth embodiment of the terminal module 100 of the present disclosure, the second conductive terminals 22 include a third outer ground terminal G3′ and a fourth outer ground terminal G4′. In the illustrated embodiment of the present disclosure, the third outer ground terminal G3′ and the fourth outer ground terminal G4′ are the two outermost terminals of the second conductive terminal 22, respectively, along the third direction A3-A3.

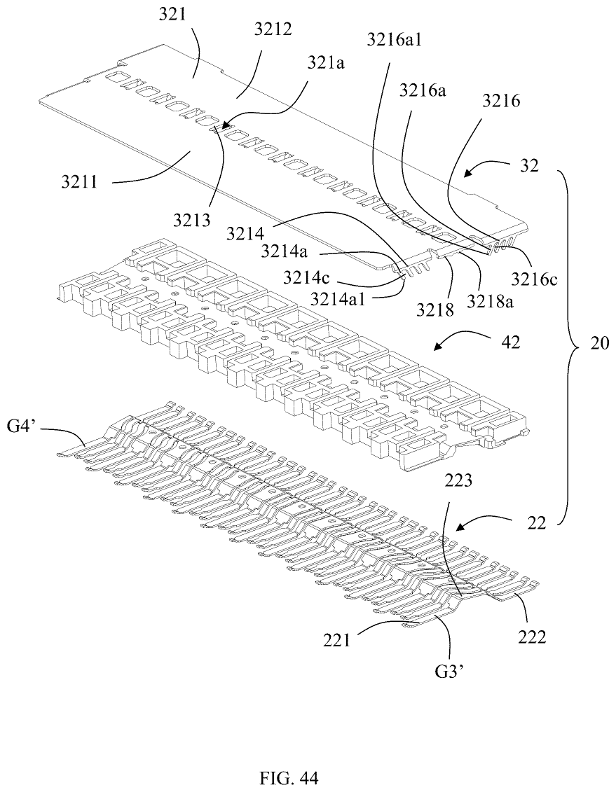

Referring to FIG. 41 to FIG. 54, in the twelfth embodiment of the terminal module 100 of the present disclosure, the second shielding piece 32 is made of a metal material, and includes a second plate portion 321 at least partially embedded in the insulating body 1. The second embedded portion 2230 is positioned between the third conductive pads 221 and the second plate portion 321 along the second direction A2-A2. With this arrangement, the second embedded portion 2230 can function similarly to a conductive path on a printed circuit board. As shown in FIG. 44, in the illustrated embodiment of the present disclosure, the second plate portion 321 extends forwardly beyond the third conductive pads 221 along the first direction A1-A1, and extends rearwardly beyond the fourth conductive pads 222 along the first direction A1-A1, thereby providing improved shielding effectiveness along the entire length of both the third conductive pad 221 and the fourth conductive pad 222.

Specifically, the second shielding piece 32 includes a third shielding portion 3211 corresponding to the third conductive pads 221, a fourth shielding portion 3212 corresponding to the fourth conductive pads 222, a second connecting piece 3213 connecting the third shielding portion 3211 and the fourth shielding portion 3212, a fifth side wall portion 3214 bent from one side of the third shielding portion 3211, a sixth side wall portion 3215 bent from another side of the third shielding portion 3211, a seventh side wall portion 3216 bent from one side of the fourth shielding portion 3212, an eighth side wall portion 3217 bent from another side of the fourth shielding portion 3212, a third end wall portion 3218 bent from one side of the second connecting piece 3213, and a fourth end wall portion 3219 bent from another side of the second connecting piece 3213. The fifth side wall portion 3214, the seventh side wall portion 3216 and the third end wall portion 3218 are located on one side of the second plate portion 321, while the sixth side wall portion 3215, the eighth side wall portion 3217 and the fourth end wall portion 3219 are located on another side of the second plate portion 321. The third shielding portion 3211, the fourth shielding portion 3212 and the second connecting piece 3213 are provided on the second plate portion 321. In the illustrated embodiment of the present disclosure, the second shielding piece 32 is of a one-piece configuration to reduce manufacturing difficulty, enhance structural strength, and improve shielding effectiveness. In other words, the third shielding portion 3211, the fourth shielding portion 3212, the second connecting piece 3213, the fifth side wall portion 3214, the sixth side wall portion 3215, the seventh side wall portion 3216, the eighth side wall portion 3217, the third end wall portion 3218 and the fourth end wall portion 3219 are integrally formed.

In the illustrated embodiments of the present disclosure, both the fifth side wall portion 3214 and the seventh side wall portion 3216 are perpendicular to the third shielding portion 3211 and the fourth shielding portion 3212. The third shielding portion 3211 and the fourth shielding portion 3212 lie in a first plane (e.g., a horizontal plane) formed by the first direction A1-A1 and the third direction A3-A3, while the fifth side wall portion 3214 and the seventh side wall portion 3216 each lies in a second plane (e.g., a vertical plane) formed by the first direction A1-A1 and the second direction A2-A2. The fifth side wall portion 3214 and the seventh side wall portion 3216 are spaced apart along the first direction A1-A1, such that they can avoid mutual interference during their respective bending processes. In the illustrated embodiments of the present disclosure, the fifth side wall portion 3214 and the seventh side wall portion 3216 are staggered along the first direction A1-A1 to correspond to the third conductive pads 221 and the fourth conductive pads 222, respectively.

In the illustrated embodiment of the present disclosure, the fifth side wall portion 3214 is provided with a plurality of inclined fifth abutting elastic arms 3214a and a plurality of fifth inclined slots 3214c located between every two adjacent fifth abutting elastic arms 3214a. In the illustrated embodiment of the present disclosure, the fifth abutting elastic arms 3214a are integrally extended (e.g., stamped) from the fifth side wall portion 3214. The fifth abutting elastic arms 3214a are of cantilever-shaped configurations, and extend obliquely toward the lower right. Each fifth abutting elastic arm 3214a is provided with a fifth abutting portion 3214a1 approximately at a free end thereof. In the illustrated embodiment of the present disclosure, the fifth inclined slots 3214c are located beside the fifth abutting elastic arms 3214a to provide deformation space for the deformation of the fifth abutting elastic arms 3214a.

Similarly, in the illustrated embodiment of the present disclosure, the sixth side wall portion 3215 is provided with a plurality of inclined sixth abutting elastic arms 3215a and a plurality of sixth inclined slots 3215c located between every two adjacent sixth abutting elastic arms 3215a. In the illustrated embodiment of the present disclosure, the sixth abutting elastic arms 3215a are integrally extended (e.g., stamped) from the sixth side wall portion 3215. The sixth abutting elastic arms 3215a are of cantilever-shaped configurations, and extend obliquely toward the lower right direction. Each sixth abutting elastic arm 3215a is provided with a sixth abutting portion 3215a1 approximately at a free end thereof. In the illustrated embodiment of the present disclosure, the sixth inclined slots 3215c are located beside the sixth abutting elastic arms 3215a to provide deformation space for the deformation of the sixth abutting elastic arms 3215a.

In the illustrated embodiment of the present disclosure, the seventh side wall portion 3216 is provided with a plurality of inclined seventh abutting elastic arms 3216a and a plurality of inclined slots 3216c located between every two adjacent seventh abutting elastic arms 3216a. In the illustrated embodiment of the present disclosure, the seventh abutting elastic arms 3216a are integrally extended (e.g., stamped) from the seventh side wall portion 3216. The seventh abutting elastic arms 3216a are of cantilever-shaped configurations, and extend obliquely downward to the left. Each seventh abutting elastic arm 3216a is provided with a seventh abutting portion 3216a1 approximately at a free end thereof. In the illustrated embodiment of the present disclosure, the seventh inclined slots 3216c are located beside the seventh abutting elastic arms 3216a to provide deformation space for the deformation of the seventh abutting elastic arms 3216a. An extending direction of the seventh abutting elastic arm 3216a differs from that of the fifth abutting elastic arm 3214a, bringing the seventh contact portions 3216a1 and the fifth contact portions 3214a1 as close as possible to the center, thereby improving the contact effect between the second shielding piece 32 and the corresponding second conductive terminals 22. The seventh abutting elastic arms 3216a and the fifth abutting elastic arms 3214a are staggered along the first direction A1-A1.

Similarly, in the illustrated embodiment of the present disclosure, the eighth side wall portion 3217 is provided with a plurality of inclined eighth abutting elastic arms 3217a and a plurality of eighth inclined slots 3217c located between every two adjacent eighth abutting elastic arms 3217a. In the illustrated embodiment of the present disclosure, the eighth abutting elastic arms 3217a are integrally extended (e.g., stamped) from the eighth side wall portion 3217. The eighth abutting elastic arms 3217a are of cantilever-shaped configurations, and extend obliquely toward the lower left direction. Each eighth abutting elastic arm 3217a is provided with an eighth abutting portion 3217a1 approximately at a free end thereof. In the illustrated embodiment of the present disclosure, the eighth inclined slots 3217c are located beside the eighth abutting elastic arms 3217a to provide deformation space for the deformation of the eighth abutting elastic arms 3217a. An extending direction of the eighth abutting elastic arm 3217a differs from that of the sixth abutting elastic arm 3215a, causing the eighth abutting portion 3217a1 and the sixth abutting portion 3215a1 to approach the center as closely as possible, thereby improving the contact effect between the second shielding piece 32 and the corresponding second conductive terminals 22. The eighth abutting elastic arms 3217a and the sixth abutting elastic arms 3215a are staggered along the first direction A1-A1.

Besides, the second connecting piece 3213 of the second plate portion 321 defines a plurality of second openings 321a that extend through the second connecting piece 3213 along the second direction A2-A2. The second shielding piece 32 is fixed to the second insulating block 42 by assembly, or the second insulating block 42 is injection-molded on the second shielding piece 32.

The third end wall portion 3218 is provided with a plurality of approximately tooth-shaped third abutting protrusions 3218a, and the fourth end wall portion 3219 is provided with a plurality of approximately tooth-shaped fourth abutting protrusions 3219a.

In the illustrated embodiment of the present disclosure, the fifth abutting portion 3214a1 of the fifth abutting elastic arm 3214a is in elastic contact with the third conductive pad 221 of the third outer ground terminal G3′. The sixth abutting portion 3215a1 of the sixth abutting elastic arm 3215a is in elastic contact with the third conductive pad 221 of the fourth outer ground terminal G4′. The seventh abutting portion 3216a1 of the seventh abutting elastic arm 3216a is in elastic contact with the fourth conductive pad 222 of the third outer ground terminal G3′. The eighth abutting portion 3217a1 of the eighth abutting elastic arm 3217a is in elastic contact with the fourth conductive pad 222 of the fourth outer ground terminal G4′. As a result, this configuration improves the grounding shielding effect.

Besides, the third abutting protrusion 3218a is in contact with the second intermediate portion 223 of the third outer ground terminal G3′, and the fourth abutting protrusion 3219a is in contact with the second intermediate portion 223 of the fourth outer ground terminal G4′. As a result, this arrangement further enhances the grounding shielding effect.

Besides, in the illustrated embodiment of the present disclosure, both the third shielding portion 3211 and the fourth shielding portion 3212 are complete, meaning that neither the third shielding portion 3211 nor the fourth shielding portion 3212 has any openings along the second direction A2-A2 that extend through them. This enhances the shielding effect on the third conductive pads 221 and the fourth conductive pads 222, reduces signal crosstalk, and improves signal integrity.

In the illustrated embodiment of the present disclosure, the first plate portion 311 of the first shielding piece 31 is in contact with the second plate portion 321 of the second shielding piece 32. In the illustrated embodiment of the present disclosure, the first plate portion 311 of the first shielding piece 31 and the second plate portion 321 of the second shielding piece 32 are adhered to each other along the second direction A2-A2. The shape and size of the first shielding portion 3111 of the first shielding piece 31 are the same as those of the third shielding portion 3211 of the second shielding piece 32. The first shielding portion 3111 of the first shielding piece 31 and the third shielding portion 3211 of the second shielding piece 32 together form a first shielding layer P1 located between the first conductive pads 211 of the first conductive terminals 21 and the third conductive pads 221 of the second conductive terminals 22. As a whole, the first shielding layer P1 is at least free of any openings extending through it along the second direction A2-A2, thereby reducing signal crosstalk between the first conductive pads 211 of the first conductive terminals 21 and the third conductive pads 221 of the second conductive terminals 22.

Similarly, the shape and size of the second shielding portion 3112 of the first shielding piece 31 are identical to those of the fourth shielding portion 3212 of the second shielding piece 32. The first shielding portion 3111 of the first shielding piece 31 and the fourth shielding portion 3212 of the second shielding piece 32 together form a second shielding layer P2, located between the second conductive pads 212 of the first conductive terminals 21 and the fourth conductive pads 222 of the second conductive terminals 22. As a whole, the second shielding layer P2 does not have any openings that extend through it along the second direction A2-A2, thereby reducing signal crosstalk between the second conductive pads 212 of the first conductive terminals 21 and the fourth conductive pads 222 of the second conductive terminals 22.

Compared to related technologies, by providing the first side wall portion 3114, the second side wall portion 3115, the third side wall portion 3116 and the fourth side wall portion 3117 on the first shielding piece 31 of the present disclosure, and by providing the first abutting elastic arm 3114a, the second abutting elastic arm 3115a, the third abutting elastic arm 3116a and the fourth abutting elastic arm 3117a on the side wall portions, respective, it enables the first shielding portion 3111 and the second shielding portion 3112 to be of an integrated structure, thereby avoiding the need for openings on the first shielding portion 3111 and the second shielding portion 3112 that would compromise optimal shielding performance.

Similarly, by providing the fifth side wall portion 3214, the sixth side wall portion 3215, the seventh side wall portion 3216 and the eighth side wall portion 3217 on the second shielding piece 32 of the present disclosure, and by providing the fifth abutting elastic arm 3214a, the sixth abutting elastic arm 3215a, the seventh abutting elastic arm 3216a and the eighth abutting elastic arm 3217a on the side wall portions, respective, it enables the third shielding portion 3211 and the fourth shielding portion 3212 to be of an integral structure, thereby avoiding the need for openings on the third shielding portion 3211 and the fourth shielding portion 3212 that would compromise optimal shielding performance.

In the illustrated embodiment of the present disclosure, neither the first shielding portion 3111 nor the third shielding portion 3211 of the first shielding layer P1 is provided with any openings extending along the second direction A2-A2, thereby ensuring a double-layered shielding effect of the first shielding layer P1. Of course, it is understandable to those skilled in the art that one of the first shielding portion 3111 and the third shielding portion 3211 may also be provided with an opening at an overlapping position, as long as the opening is covered by the other of the first shielding portion 3111 and the third shielding portion 3211. This configuration ensures that, as a whole, the first shielding layer P1 has no openings extending through it along the second direction A2-A2, thereby also improving the shielding effect.

In the illustrated embodiments of the present disclosure, neither the second shielding portion 3112 nor the fourth shielding portion 3212 of the second shielding layer P2 is provided with any openings extending along the second direction A2-A2, thereby ensuring a double-layered shielding effect of the second shielding layer P2. Of course, it is understandable to those skilled in the art that one of the second shielding portion 3112 and the fourth shielding portion 3212 may also be provided with an opening at an overlapping position, as long as the opening is covered by the other of the second shielding portion 3112 and the fourth shielding portion 3212. This configuration ensures that, as a whole, the second shielding layer P2 does not have any openings extending along the second direction A2-A2, thereby also improving the shielding effect.

The present disclosure also discloses a manufacturing method of the terminal module 100 described above, including:
providing the first conductive terminal 21;
providing the first shielding piece 31;
injection-molding the first insulating block 41 on the first conductive terminals 21 and the first shielding piece 31, so that the first conductive terminals 21, the first shielding piece 31 and the first insulating block 41 are combined into a first terminal assembly 10;
providing the second conductive terminal 22;
providing the second shielding piece 32;
injection-molding the second insulating block 42 on the second conductive terminals 22 and the second shielding piece 32, so that the second conductive terminals 22, the second shielding piece 32 and the second insulating block 42 are combined into a second terminal assembly 20;
assembling the first terminal assembly 10 and the second terminal assembly 20 together; and
injection-molding a third insulating block 43 on the first terminal assembly 10 and the second terminal assembly 20; wherein the third insulating block 43 is molded on the first insulating block 41 and the second insulating block 42 to form the insulating body 1.

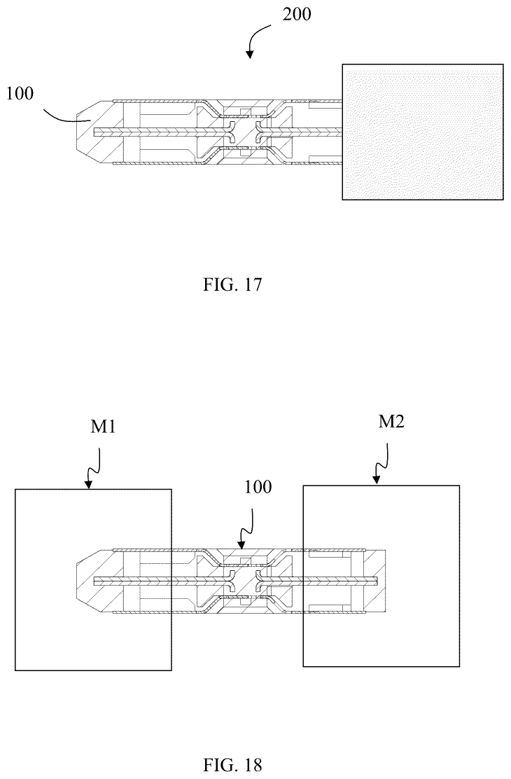

Referring to FIG. 17, the present disclosure also discloses an application of the above-mentioned terminal module 100. The terminal module 100 is a component of an electrical connector 200, replacing a printed circuit board. The component may be a tongue plate or an adapter module. When the component is the tongue plate, the tongue plate is used to be inserted into a slot of a mating connector. The first conductive pads 211 are used to be in contact with mating conductive terminals of the mating connector to achieve electrical connection.

Referring to FIG. 18, when the component is the adapter module, the first conductive pads 211 and the second conductive pads 212 serve as bridges to connect with a first component M1 and a second component M2, respectively.

Compared with the prior art, it is understandable to those skilled in the art that by embedding the first embedded portion 2130 in the insulating body 1, the first conductive terminal 21 can be better fixed to the insulating body 1, thereby reducing the risk of falling off between the two. In addition, the first embedded portion 2130 cooperates with the insulating body 1 to facilitate adjustment of impedance. The terminal module 100 of the present disclosure is able to replace the printed circuit board in the related art, so as to better be adaptable to the development requirements of high-speed connectors in terms of dimension control and impedance adjustment.

The above embodiments are only used to illustrate the present disclosure and not to limit the technical solutions described in the present disclosure. The understanding of this specification should be based on those skilled in the art. Descriptions of directions, although they have been described in detail in the above-mentioned embodiments of the present disclosure, those skilled in the art should understand that modifications or equivalent substitutions can still be made to the application, and all technical solutions and improvements that do not depart from the spirit and scope of the application should be covered by the claims of the application.

What is claimed is:

1. A terminal module, comprising:
a plurality of first conductive terminals, the plurality of first conductive terminals comprising a first outer ground terminal, a second outer ground terminal, and at least one signal terminal located between the first outer ground terminal and the second outer ground terminal; each first conductive terminal comprising a first conductive pad, a second conductive pad, and a first intermediate portion connecting the first conductive pad and the second conductive pad; the first conductive pad and the second conductive pad being disposed at intervals along a first direction;
an insulating body, the insulating body comprising a first surface and a second surface disposed opposite to the first surface along a second direction; the first conductive pads and the second conductive pads are exposed on the first surface; and
a first shielding piece, the first shielding piece comprising a first shielding portion at least partially disposed in the insulating body, a first side wall portion bent from one side of the first shielding portion, and a second side wall portion bent from another side of the first shielding portion; the first shielding portion corresponding to the first conductive pads; the first side wall portion being provided with a first abutting elastic arm; the first abutting elastic arm being provided with a first abutting portion; the second side wall portion being provided with a second abutting elastic arm; the second abutting elastic arm being provided with a second abutting portion; the first abutting portion being in contact with the first conductive pad of the first outer ground terminal; and the second abutting portion being in contact with the first conductive pad of the second outer ground terminal.

2. The terminal module according to claim 1, wherein the first shielding portion is not provided with any opening extending through the first shielding portion along the second direction.

3. The terminal module according to claim 1, wherein the first shielding portion extends beyond the first conductive pads along the first direction.

4. The terminal module according to claim 1, wherein a plurality of signal terminals are provided, and projections of the first conductive pads of all the signal terminals along the second direction fall within a range of the first shielding portion.

5. The terminal module according to claim 1, wherein the first abutting elastic arm integrally extends from the first side wall portion; the first side wall portion defines a first accommodating groove corresponding to the first abutting elastic arm; and the first accommodating groove is configured to provide a space for deformation of the first abutting elastic arm.

6. The terminal module according to claim 5, wherein the first abutting elastic arm is in a cantilever shape, and the first abutting portion is in a raised arc shape.

7. The terminal module according to claim 1, wherein the first shielding piece comprises a second shielding portion, a third side wall portion bent from one side of the second shielding portion, and a fourth side wall portion bent from another side of the second shielding portion; the second shielding portion corresponds to the second conductive pads; the third side wall portion is provided with a third abutting elastic arm; the third abutting elastic arm is provided with a third abutting portion; the fourth side wall portion is provided with a fourth abutting elastic arm; the fourth abutting elastic arm is provided with a fourth abutting portion; the third abutting portion is in contact with the second conductive pad of the first outer ground terminal; and the fourth abutting portion is in contact with the second conductive pad of the second outer ground terminal.

8. The terminal module according to claim 7, wherein the first side wall portion and the third side wall portion are located on one side of the first shielding piece, and extending directions of the first abutting elastic arm and the third abutting elastic arm are opposite to each other; and
wherein the second side wall portion and the fourth side wall portion are located on another side of the first shielding piece, and extending directions of the second abutting elastic arm and the fourth abutting elastic arm are opposite to each other.

9. The terminal module according to claim 7, wherein the at least one signal terminal is located between the first outer ground terminal and the second outer ground terminal along a third direction; and each two of the first direction, the second direction and the third direction are perpendicular to each other.

10. The terminal module according to claim 9, wherein the first shielding portion and the second shielding portion are located in a first plane formed by the first direction and the third direction;
the first abutting elastic arm, the second abutting elastic arm, the third abutting elastic arm, and the fourth abutting elastic arm are located in a second plane formed by the second direction and the third direction; and the first plane is perpendicular to the second plane.

11. The terminal module according to claim 1, wherein a plurality of first abutting elastic arms are provided and are arranged obliquely; the first side wall portion is provided with first oblique slots located between every two adjacent first abutting elastic arms;
a plurality of second abutting elastic arms are provided and are arranged obliquely; the second side wall portion is provided with second oblique slots located between every two adjacent second abutting elastic arms.

12. The terminal module according claim 1, further comprising:
a plurality of second conductive terminals, the plurality of second conductive terminals comprising a third outer ground terminal and a fourth outer ground terminal; each second conductive terminal comprising a third conductive pad, a fourth conductive pad, and a second intermediate portion connecting the third conductive pad and the fourth conductive pad; the third conductive pad and the fourth conductive pad being disposed at intervals along the first direction; and
a second shielding piece, the second shielding piece comprising a third shielding portion at least partially disposed in the insulating body, a fifth side wall portion bent from one side of the third shielding portion, and a sixth side wall portion bent from another side of the third shielding portion; the third shielding portion corresponding to the third conductive pads; the fifth side wall portion being provided with a fifth abutting elastic arm; the fifth abutting elastic arm being provided with a fifth abutting portion; the sixth side wall portion being provided with a sixth abutting elastic arm; the sixth abutting elastic arm being provided with a sixth abutting portion; the fifth abutting portion being in contact with the third conductive pad of the third outer ground terminal; and the sixth abutting portion being in contact with the third conductive pad of the fourth outer ground terminal;
wherein the first shielding portion of the first shielding piece and the third shielding portion of the second shielding piece together form a first shielding layer located between the first conductive pads of the first conductive terminals and the third conductive pads of the second conductive terminals along the second direction.

13. The terminal module according to claim 12, wherein the first shielding portion of the first shielding piece and the third shielding portion of the second shielding piece are in contact with each other.

14. The terminal module according to claim 12, wherein the first conductive terminals and the second conductive terminals are arranged symmetrically, and the first shielding piece and the second shielding piece are arranged symmetrically.

15. The terminal module according to claim 12, further comprising a first insulating block molded on the first conductive terminals and the first shielding piece, a second insulating block molded on the second conductive terminals and the second shielding piece, and a third insulating block secondarily molded on the first insulating block and the second insulating block;
wherein the insulating body comprises the first insulating block, the second insulating block, and the third insulating block.

16. A terminal module, comprising:
a first terminal assembly, the first terminal assembly comprising:
a plurality of first conductive terminals, the plurality of first conductive terminals comprising a first outer ground terminal, a second outer ground terminal, and at least one first signal terminal located between the first outer ground terminal and the second outer ground terminal; each first conductive terminal comprising a first conductive pad extending along a first direction;
a first insulating block, the first insulating blocking being secured with the plurality of first conductive terminals; and
a first shielding piece, the first shielding piece comprising a first shielding portion at least partially disposed in the first insulating block, a first side wall portion bent from one side of the first shielding portion, and a second side wall portion bent from another side of the first shielding portion; the first shielding portion corresponding to the first conductive pads; the first side wall portion being provided with at least one first abutting elastic arm; the at least one first abutting elastic arm being provided with at least one first abutting portion; the second side wall portion being provided with at least one second abutting elastic arm; the at least one second abutting elastic arm being provided with at least one second abutting portion; the first abutting portion being in contact with the first conductive pad of the first outer ground terminal; and the second abutting portion being in contact with the first conductive pad of the second outer ground terminal; and
a second terminal assembly, the second terminal assembly comprising:
a plurality of second conductive terminals, the plurality of second conductive terminals comprising a third outer ground terminal, a fourth outer ground terminal, and at least one second signal terminal located between the third outer ground terminal and the fourth outer ground terminal; each second conductive terminal comprising a second conductive pad extending along the first direction;
a second insulating block, the second insulating blocking being secured with the plurality of second conductive terminals; and
a second shielding piece, the second shielding piece comprising a second shielding portion at least partially disposed in the second insulating block, a third side wall portion bent from one side of the second shielding portion, and a fourth side wall portion bent from another side of the second shielding portion; the second shielding portion corresponding to the second conductive pads; the third side wall portion being provided with at least one third abutting elastic arm; the at least one third abutting elastic arm being provided with at least one third abutting portion; the fourth side wall portion being provided with at least one fourth abutting elastic arm; the at least one fourth abutting elastic arm being provided with at least one fourth abutting portion; the third abutting portion being in contact with the second conductive pad of the third outer ground terminal; and the fourth abutting portion being in contact with the second conductive pad of the fourth outer ground terminal;
wherein the first shielding portion of the first shielding piece and the second shielding portion of the second shielding piece together form a first shielding layer located between the first conductive pads of the first conductive terminals and the second conductive pads of the second conductive terminals; and
wherein the first shielding layer is free of any openings extending through the first shielding layer along a second direction perpendicular to the first direction, so as to reduce signal crosstalk between the first conductive pads of the first conductive terminals and the second conductive pads of the second conductive terminals.

17. The terminal module according to claim 16, wherein the first shielding portion of the first shielding piece and the second shielding portion of the second shielding piece are adhered to each other along the second direction.

18. A method for manufacturing the terminal module according to claim 12, comprising:
providing the plurality of first conductive terminals;
providing the first shielding piece;
injection-molding a first insulating block on the first conductive terminals and the first shielding piece to form a first terminal assembly;
providing the plurality of second conductive terminals;
providing the second shielding piece;
injection-molding a second insulating block on the second conductive terminals and the second shielding piece to form a second terminal assembly;
assembling the first terminal assembly and the second terminal assembly together; and
injection-molding a third insulating block on the first terminal assembly and the second terminal assembly to form the insulating body.

19. An application of the terminal module according to claim 12, wherein the terminal module is a component of an electrical connector, and the terminal module is configured to replace a printed circuit board.

20. The application according to claim 19, wherein the component is a tongue plate or an adapter module.
